(19) United States
(12) Patent Application Publication
(10) Pub. No.: US 2026/0371241 A1
(43) Pub. Date: Nov. 19, 2026

(54) A Wireless Device, Network Node, and Methods Performed Thereby, for Handling a Wake-up Receiver

(71) Applicant: Telefonaktiebolaget LM Ericsson (publ), Stockholm (SE)

(72) Inventors: Andreas Höglund, Solna (SE); Mohammad Mozaffari, Fremont, CA (US); Yanpeng Yang, Järfälla (SE)

(21) Appl. No.: 19/125,853

(22) PCT Filed: Nov. 1, 2023
(86) PCT No.: PCT/SE2023/051092

§ 371 Date: Apr. 30, 2025

Related U.S. Application Data
(60) Provisional application No. 63/381,788, filed on Nov. 1, 2022.

(51) Int. Cl. H04W 52/02; H04W 76/28

(52) U.S. Cl. CPC H04W 52/0216; H04W 52/0235; H04W 52/028; H04W 76/28

(57) ABSTRACT

A method, performed by a wireless device (130), for handling a wake-up receiver. The wireless device (130) operates in a wireless communications network (100). The wireless device (130) determines (505), while the wireless device (130) is in connected mode, whether or not to activate a wake-up receiver. The determining (505) is based on an expiration of a first timer. The wireless device (130) initiates (506) activation, while the wireless device (130) is in connected mode, of the wake-up receiver based on a result of the determination. The wireless device (130) then monitors (507) a downlink transmission with the activated wake-up receiver.

### TECHNICAL FIELD

The present disclosure relates generally to a wireless device and methods performed thereby for handling a wake-up receiver. The present disclosure further relates generally to a network node and methods performed thereby, for handling the wake-up receiver.

### BACKGROUND

Wireless devices within a wireless communications network may be e.g., User Equipments (UEs), stations (STAs), mobile terminals, wireless terminals, terminals, and/or Mobile Stations (MS). Wireless devices are enabled to communicate wirelessly in a cellular communications network or wireless communication network, sometimes also referred to as a cellular radio system, cellular system, or cellular network. The communication may be performed e.g., between two wireless devices, between a wireless device and a regular telephone and/or between a wireless device and a server via a Radio Access Network (RAN) and possibly one or more core networks, comprised within the wireless communications network. Wireless devices may further be referred to as mobile telephones, cellular telephones, laptops, or tablets with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another terminal or a server.

The wireless communications network covers a geographical area which may be divided into cell areas, each cell area being served by a network node, which may be an access node such as a radio network node, radio node or a base station, e.g., a Radio Base Station (RBS), which sometimes may be referred to as e.g., gNB, evolved Node B (“eNB”), “eNodeB”, “NodeB”, “B node”, Transmission Point (TP), or BTS (Base Transceiver Station), depending on the technology and terminology used. The base stations may be of different classes such as e.g., Wide Area Base Stations, Medium Range Base Stations, Local Area Base Stations, Home Base Stations, pico base stations, etc. . . . , based on transmission power and thereby also cell size. A cell is the geographical area where radio coverage is provided by the base station or radio node at a base station site, or radio node site, respectively. One base station, situated on the base station site, may serve one or several cells. Further, each base station may support one or several communication technologies. The base stations communicate over the air interface operating on radio frequencies with the terminals within range of the base stations. The wireless communications network may also be a non-cellular system, comprising network nodes which may serve receiving nodes, such as wireless devices, with serving beams. In 3rd Generation Partnership Project (3GPP) Long Term Evolution (LTE), base stations, which may be referred to as eNodeBs or even eNBs, may be directly connected to one or more core networks. In the context of this disclosure, the expression Downlink (DL) may be used for the transmission path from the base station to the wireless device. The expression Uplink (UL) may be used for the transmission path in the opposite direction i.e., from the wireless device to the base station.

The standardization organization 3GPP is currently in the process of specifying a New Radio Interface called NR or 5G-UTRA, as well as a Fifth Generation (5G) Packet Core Network (CN), which may be referred to as Next Generation (NG) Core Network, abbreviated as NG-CN, NGC, 5G CN or 5G Core (5GC). NG may be understood to refer to the interface/reference point between the Radio Access Network (RAN) and the CN in 5G/NR. In a 5G System (5GS), a radio base station in NR may be referred to as a gNB or 5G Node B. An NR UE may be referred to as an nUE.

### Internet of Things (IoT)

The Internet of Things (IoT) may be understood as an internetworking of communication devices, e.g., physical devices, vehicles, which may also referred to as “connected devices” and “smart devices”, buildings and other items-embedded with electronics, software, sensors, actuators, and network connectivity that may enable these objects to collect and exchange data. The IoT may allow objects to be sensed and/or controlled remotely across an existing network infrastructure.

“Things,” in the IoT sense, may refer to a wide variety of devices such as heart monitoring implants, biochip transponders on farm animals, electric clams in coastal waters, automobiles with built-in sensors, DNA analysis devices for environmental/food/pathogen monitoring, or field operation devices that may assist firefighters in search and rescue operations, home automation devices such as the control and automation of lighting, heating, e.g. a “smart” thermostat, ventilation, air conditioning, and appliances such as washer, dryers, ovens, refrigerators or freezers that may use telecommunications for remote monitoring. These devices may collect data with the help of various existing technologies and then autonomously flow the data between other devices.

It is expected that in a near future, the population of IoT devices will be very large. Various predictions exist, among which one assumes that there will be >60000 devices per square kilometer, and another assumes that there will be 1000000 devices per square kilometer. A large fraction of these devices are expected to be stationary, e.g., gas and electricity meters, vending machines, etc.

### Machine Type Communication (MTC)

Machine Type Communication (MTC) has in recent years, especially in the context of the Internet of Things (IoT), shown to be a growing segment for cellular technologies. An MTC device may be a communication device, typically a wireless communication device or simply user equipment, that is a self and/or automatically controlled unattended machine and that is typically not associated with an active human user in order to generate data traffic. An MTC device may be typically simpler, and typically associated with a more specific application or purpose, than, and in contrast to, a conventional mobile phone or smart phone. MTC involves communication in a wireless communication network to and/or from MTC devices, which communication typically may be of quite different nature and with other requirements than communication associated with e.g. conventional mobile phones and smart phones. In the context of and growth of the IoT, it is evident that MTC traffic will be increasing and thus needs to be increasingly supported in wireless communication systems.

Wake-up receiver (WUR), sometimes also referred to as ‘wake-up radio’, may be understood to relate to enabling a low power receiver in UEs, which, in case of the detection of a ‘Wake-up signal’ (WUS), may wake up the main, e.g., baseband/higher power, receiver to detect an incoming message, typically paging, e.g., the Physical Downlink Control Channel (PDCCH) in paging occasions (POs), scheduling the paging message on the Physical Downlink Shared Channel (PDSCH). The main benefit of employing WUR may be understood to be energy consumption and longer device battery life, or at a fixed energy consumption, the downlink latency may be reduced, there may be shorter Discontinued Reception (DRX)/duty-cycles, and more frequent checks for incoming transmissions.

FIG. 1 is a schematic diagram illustrating location of a WUS and the paging occasion (PO) to which it is associated. In FIG. 1, white blocks indicate possible WUS, and PO positions, whereas the black boxes indicate actual WUS and PO positions.

### WUS for NB-IoT and LTE-M

### Release 15

In Rel-15, WUS was specified for NarrowBand IoT (NB-IoT) and Long Term Evolution for Machines (LTE-M). The main motivation was UE energy consumption reduction since, with the coverage enhancement, PDCCH may be repeated many times and the WUS may be relatively much shorter and hence may require less reception time for the UE. The logic may be understood to be that a UE may check for a WUS a certain time before its PO, and only if a WUS is detected, the UE may continue to check for PDCCH in the PO, and if not, which is most of the time, the UE may go back to a sleep state to conserve energy. Due to the coverage enhancements, the WUS may be of variable length depending on the coverage of the UE, see FIG. 2.

FIG. 2 is a schematic diagram illustrating WUS for NB-IoT and LTE-M. As depicted in FIG. 2, where the horizontal axis represents time, the WUS may have a duration, which may be a fraction of a configured maximum WUS duration. Between the end of the configured maximum WUS duration and the beginning of the associated paging occasion (PO) there may be a gap. A gap may be understood as a time offset between the WUS monitoring occasion and the paging occasion. A gap may also be referred to as an offset.

A WUS may be based on the transmission of a short signal that may indicate to the UE that it may need to continue to decode the Downlink (DL) control channel e.g., the full Narrowband PDCCH (NPDCCH) for NB-IoT. If such signal is absent, e.g., in Discontinuous Transmission (DTX) that is, if the UE does not detect it, then the UE may go back to sleep without decoding the DL control channel. The decoding time for a WUS may be considerably shorter than that of the full NPDCCH since it may only need to contain one bit of information, whereas the NPDCCH may contain up to 35 bits of information. This, in turn, may be understood to reduce UE power consumption and lead to longer UE battery life. The WUS would be transmitted only when there may be paging for the UE. But if there is no paging for the UE, then the WUS may be understood to not be transmitted, implying a discontinuous transmission (DTX) and the UE may go back to deep sleep e.g., upon detecting DTX instead of WUS. This is illustrated in FIG. 1, where white blocks indicate possible WUS, and PO positions whereas the black boxes indicate actual WUS and PO positions.

The specification of Rel-15 WUS is spread out over several parts of the LTE 36-series standard, e.g., 36.211, 36.213, 36.304 and 36.331.

A UE may report its WUS capability to the network, and WUS gap capability, that is, the minimum time required for the UE to start up its main receiver, see below. Further WUS information was added in the specification to the paging message/request from Mobility Management Entity (MME) to an eNB, see UE radio paging capabilities. An eNB may use WUS for paging the UE if and only if (IFF) 1) WUS is enabled in the cell, e.g., WUS-Config may be present in System Information (SI), and 2) the UE may support WUS according to the wakeUpSignal-r15 UE capability, see also the description of WUS gap below.

WUS was introduced for both LTE-M and NB-IoT with support for both DRX and extended DRX (eDRX), the former with a 1-to-1 mapping between the WUS and the PO, and for the latter in an addition with the possible configuration of 1-to-N, many, POs. An eNB may configure one WUS gap for UEs using DRX, and another one for UEs using eDRX, see e.g., TS 36.331, version 16.6.0, examples are given for NB-IoT, LTE-M is similar:

WUS-Config-NB information element

| | |
|---|---|
| WUS-Config-NB-r15 ::= | SEQUENCE { |
| maxDurationFactor-15 | WUS-MaxDurationFactor-NB-r15 |
| numPOs-r15 | ENUMERATED {n1, n2, n4} DEFAULT n1, |
| numDRX-CyclesRelaxed-r15 | ENUMERATED {n1, n2, n4, n8}, |
| timeOffsetDRX-r15 | ENUMERATED {ms40, ms80, ms160, ms240}, |
| timeOffset-eDRX-Short-r15 | ENUMERATED {ms40, ms80, ms160, ms240}, |
| timeOffset-eDRX-Long-r15 | ENUMERATED {ms1000, ms2000} OPTIONAL, -- Need OP |

...
}

| | |
|---|---|
| WUS-ConfigPerCarrier-NB-r15 ::= | SEQUENCE { |
| maxDurationFactor-r15 | WUS-MaxDurationFactor-NB-r15 |

}

| | |
|---|---|
| WUS-MaxDurationFactor-NB-r15 ::= | ENUMERATED {one128th, one64th, one32th, one16th, |
| | oneEighth, oneQuarter, oneHalf} |

WUS-Config-NB field descriptions

timeOffsetDRX
When DRX is used, non-zero gap from the end of the configured maximum WUS duration to the
associated PO, see TS 36.304 [4], clause 7.4 and TS 36.211 [21]. In milliseconds. Value ms40
corresponds to 40 ms, value ms80 corresponds to 80 ms and so on.
timeOffset-eDRX-Short
When eDRX is used, the short non-zero gap from the end of the configured maximum WUS duration to
the associated PO, see TS 36.304 [4], clause 7.4 and TS 36.211 [21]. In milliseconds. Value ms40
corresponds to 40 ms, value ms80 corresponds to 80 ms and so on.
E-UTRAN configures timeOffset-eDRX-Short to a value longer than or equal to timeOffsetDRX.
timeOffset-eDRX-Long
When eDRX is used, the long non-zero gap from the end of the configured maximum WUS duration to
the associated PO, see TS 36.304 [4], clause 7.4 and TS 36.211 [21]. In milliseconds. Value ms1000
corresponds to 1000 ms, value ms2000 corresponds to 2000 ms.

The UE capabilities may also indicate the minimum WUS gaps required for the UE to be able to decode PDCCH in the associated PO, for DRX and eDRX, respectively, see TS 36.331, version 16.6.0:

UE-RadioPagingInfo-NB information element

| UE-RadioPagingInfo-NB-r13 ::= | SEQUENCE { | |
|---|---|---|
| ue-Category-NB-r13 | ENUMERATED {nb1} | OPTIONAL, |

...,

| | | |
|---|---|---|
| [[ multiCarrierPaging-r14 | ENUMERATED {true} | OPTIONAL |

]],

| | | | |
|---|---|---|---|
| [[ | mixedOperationMode-r15 | ENUMERATED {supported} | OPTIONAL, |
| | wakeUpSignal-r15 | ENUMERATED {true} | OPTIONAL, |
| | wakeUpSignalMinGap-eDRX-r15 | ENUMERATED {ms40, ms240, ms1000, ms2000} | OPTIONAL, |
| | multiCarrierPagingTDD-r15 | ENUMERATED {true} | OPTIONAL |

]],

| | | | |
|---|---|---|---|
| [[ | ue-Category-NB-r16 | ENUMERATED: {nb2} | OPTIONAL, |
| | groupWakeUpSignal-r16 | ENUMERATED {true} | OPTIONAL, |
| | groupWakeUpSignalAlternation-r16 | ENUMERATED {true} | OPTIONAL |

]]
}

wakeUpSignalMinGap-eDRX

wakeUpSignalMinGap-eDRX may be understood to indicate the minimum gap the UE may support between WUS or Group WUS (GWUS) and associated PO in case of eDRX in Frequency Division Duplexing (FDD), as specified in TS 36.304, version 16.5.0. Value ms40 corresponds to 40 ms, value ms240 corresponds to 240 ms and so on. If this field is included, the UE may be required to also indicate support for WUS or GWUS for paging in DRX.

At the end of Rel-15, a longer WUS gap of 1s or 2s was introduced to enable the use of a Wake-Up receiver (WUR), since, starting up the main baseband receiver if a WUR is used for the detection of WUS may take longer time. If this is supported in the cell, an eNB may include timeOffset-eDRX-Long in the WUS-Config in SI, see above. In TS 36.304, version 16.5.0, the UE behavior for monitoring paging with WUS is specified, and in Table 7.4-1 it is indicated which WUS time gap the UE and the eNB may be required to apply depending on the reported UE capability.

Paging with Wake Up Signal

Section 7.4 of TS 36.304, version 16.5.0 describes a specification of paging with wake up signal. According to this specification, paging with Wake Up Signal may only be used in the cell in which the UE most recently entered RRC_IDLE triggered by: a) reception of RRCEarlyDataComplete, or b) reception of RRCConnectionRelease not including noLastCellUpdate, or c) reception of RRCConnectionRelease including noLastCellUpdate and the UE was using (G) WUS in this cell prior to this Radio Resource Control (RRC) connection attempt.

If the UE is in RRC_IDLE, the UE may not be using GWUS according to clause 7.5 and the UE supports WUS, and WUS configuration may be provided in system information, the UE may be required to monitor WUS using the WUS parameters provided in System Information. When DRX is used and the UE detects WUS, the UE may be required to monitor the following PO. When extended DRX is used and the UE detects WUS, the UE may be required to monitor the following numPOs POs or until a paging message including the UE's Non-Access Stratum (NAS) identity may be received, whichever may be earlier. If the UE does not detect WUS, the UE may not be required to monitor the following PO(s). If the UE missed a WUS occasion, e.g., due to cell reselection, it may monitor every PO until the start of the next WUS or until the paging time window (PTW) ends, whichever may be earlier. A PTW may be understood as a time window containing one or more paging occasions (POs) which may be required to be monitored by the UE in eDRX operation.

numPOs=Number of consecutive Paging Occasions (PO) mapped to one WUS provided in system information where (numPOs≥1).

The WUS configuration, provided in system information, may include a time-offset between the end of WUS and the start of the first PO of the numPOs POs the UE may be required to monitor. The timeoffset in subframes, used to calculate the start of a subframe g0, see TS 36.213, version 16.7.1, may be defined as follows. For a UE using DRX, it may be the signalled timeoffsetDRX. For a UE using eDRX, it may be the signalled timeoffset-eDRX-Short if timeoffset-eDRX-Long is not broadcasted. And for a UE using eDRX, it may be the value determined according to Table 7.4-1 if timeoffset-eDRX-Long is broadcasted.

TABLE 7.4-1
Determination of GAP between end of WUS and associated PO

| | | timeoffset-eDRX-Long | |
|---|---|---|---|
| | | 1000 ms | 2000 ms |
| UE Reported | 40 ms or | timeoffset-eDRX-Short | timeoffset-eDRX-Short |
| wakeUpSignalMinGap- | not | | |
| eDRX | reported | | |
| | 240 ms | timeoffset-eDRX-Short | timeoffset-eDRX-Short |
| | 1000 ms | timeoffset-eDRX-Long | timeoffset-eDRX-Long |
| | 2000 ms | timeoffset-eDRX-Short | timeoffset-eDRX-Long |

The timeoffset may be used to determine the actual subframe g0 as follows, taking into consideration resultant System Frame number (SFN) and/or Hyper Frame SFN (H-SFN) wrap-around of this computation: g0=PO-timeoffset, where PO is the Paging Occasion subframe as defined in clause 7.1.

For a UE using eDRX, the same timeoffset may apply between the end of WUS and associated first PO of the numPOs POs for all the WUS occurrences for a PTW.

The timeoffset, g0, may be used to calculate the start of the WUS as defined in TS 36.213, version 16.7.1.

In essence, the UE may only use WUR, or timeOffset-eDRX-Long, if it may be capable of starting up the main receiver as quickly as indicated by the value used in SI. If not, it may fall back to using timeOffset-eDRX-Short, without WUR.

Since UEs may share PO, the eNB may, in the worst case, have to transmit up to 3 WUSs for one PO, for example, corresponding to timeoffsetDRX, timeoffset-eDRX-Short, and timeoffset-eDRX-Long.

FIG. 3 is a schematic diagram illustrating the use of eDRX and DRX WUS gaps for NB-IoT and LTE-M. In the non-limiting example depicted in FIG. 3, a first WUS is transmitted having a timeoffset-eDRX-Long between its transmission and that of the PDCCH in the PO. A second WUS is transmitted having a shorter, timeoffsetDRX, between the transmission of the second WUS and that of the PDCCH in the PO. After the PDCCH, the PDSCH may be transmitted.

### WUS UE Grouping Objective in Rel-16

In the Rel-16 WID, it was agreed that WUS should be further developed to also include UE grouping, such that the number of UEs that may be triggered by a WUS may be further narrowed down to a smaller subset of the UEs that may be associated with a specific paging occasion (PO). The objective was to specify the following set of improvements for machine-type communications for Bandwidth reduced Low complexity/Coverage Enhancement (BL/CE) UEs: Improved DL transmission efficiency and/or UE power consumption. Particularly, to specify support for UE-group wake-up signal (WUS) [RAN1, RAN2, RAN4].

The purpose may be understood to be to reduce the false paging rate, that is, to avoid that that a given UE may be unnecessarily woken up by a WUS transmission intended for another UE. This feature may be referred to as Rel-16 group WUS, or GWUS. However, this is not directly related to WUR and will not further be explained here.

### Rel-17 NR PEI

In Rel-17, discussions started on introducing a WUS for NR, then called ‘Paging Early Indication’ (PEI). However, since at the time no coverage enhancement was specified for NR, the only gain for Rel-17 PEI was for scenarios where the small fraction of UEs are in bad coverage and with large synchronization error due to the use of longer DRX cycles. The gain for such UEs was that, with the use of PEI, they would typically only have to acquire one Synchronisation Signal Block (SSB) before decoding PEI, instead of up to 3 SSBs if PEI was not used, value according to UE vendors. Accordingly, for most UEs, Rel-17 PEI may not result in gains or increased performance.

Rel-17 PEI may also support UE grouping for false paging reduction, similar to the Rel-16 GWUS above, which may have some gains at higher paging load.

In RAN #93e it was agreed that PEI may be PDCCH-based, as seen in from the next subsection, making it much less interesting for WUR, since the main baseband receiver may be understood to be required for decoding PEI. That is, the main baseband received may be understood to not be able to be in sleep state, and therefore there may be no WUR gains.

### Rel-18 NR WUR

In Rel-18, there has been rather large interest to introduce WUR for NR. As explained above, the only specification support needed to be able to use a WUR in the UE, may be understood to be the specification of a WUS and a long enough time gap between the WUS and the PDCCH in the PO, to allow the UE to start up the main receiver. Therefore, the main difference to Rel-17 PEI may be understood to be that the WUS in Rel-18 should not be PDCCH-based and allow for a simpler and low power receiver, that is, WUR with simple modulation and detection techniques, e.g., using On-Off Keying (OOK), modulation, and non-coherent detection.

In Rel-18, a study item on “low-power wake-up signal and receiver for NR” was approved. The relevant justification and objective sections are described as follows (RP-213645).

The justification is described as follows. 5G systems may be understood to be designed and developed targeting for both mobile telephony and vertical use cases. Besides latency, reliability, and availability, UE energy efficiency may be understood to also be critical to 5G. Currently, 5G devices may have to be recharged per week or day, depending on a usage time of an individual. In general, 5G devices may consume tens of milliwatts in RRC idle/inactive state and hundreds of milliwatts in RRC connected state. Designs to prolong battery life may be understood to be a necessity for improving energy efficiency as well as for better user experience.

Energy efficiency may be understood to be even more critical for UEs without a continuous energy source, e.g., UEs using small rechargeable and single coin cell batteries. Among vertical use cases, sensors and actuators may be deployed extensively for monitoring, measuring, charging, etc. Generally, their batteries may be understood to not be rechargeable and expected to last at least few years as described in TR 38.875. Wearables may include smart watches, rings, eHealth related devices, and medical monitoring devices. With typical battery capacity, it may be challenging to sustain up to 1-2 weeks as it may be required.

The power consumption may depend on the configured length of wake-up periods, e.g., paging cycle. To meet the battery life requirements above, eDRX cycle with large value may be expected to be used, resulting in high latency, which may not be suitable for such services with requirements of both long battery life and low latency. For example, in a fire detection and extinguishment use case, fire shutters may have to be closed and fire sprinklers may need to be turned on by the actuators within 1 to 2 seconds from the time the fire may be detected by sensors, long eDRX cycle may not meet the delay requirements, eDRX is apparently not suitable for latency-critical use cases. Thus, the intention may be understood to be to study ultra-low power mechanism that may support low latency in Rel-18, e.g. lower than eDRX latency.

Currently, UEs may need to periodically wake up once per DRX cycle, which may dominate the power consumption in periods with no signalling or data traffic. If UEs are able to wake up only when they are triggered, e.g., paging, power consumption may be dramatically reduced. This may be achieved by using a wake-up signal to trigger the main radio and a separate receiver which may have the ability to monitor wake-up signal with ultra-low power consumption. Main radio may be understood to work for data transmission and reception, which may be turned off or set to deep sleep unless it may be turned on.

The power consumption for monitoring wake-up signal may depend on the wake-up signal design and the hardware module of the wake-up receiver used for signal detecting and processing.

The study may primarily target low-power WUS/WUR for power-sensitive, small form-factor devices including IoT use cases, such as industrial sensors, controllers, and wearables. Other use cases may be understood to not be precluded, e.g., Extended Reality (XR)/smart glasses, smart phones.

The objective of the Study Item is described as follows.

As opposed to the work on UE power savings in previous releases, this study may not require existing signals to be used as WUS. All WUS solutions identified may be understood to be able to operate in a cell supporting legacy UEs. Solutions may target substantial gains compared to the existing Rel-15/16/17 UE power saving mechanisms. Other aspects such as detection performance, coverage, UE complexity, may be covered by the evaluation.

The study item includes the following objectives. One objective may be to identify evaluation methodology, including the use cases, and Key Performance Indicators (KPIs) [RAN1]. This objective may primarily target low-power WUS/WUR for power-sensitive, small form-factor devices including IoT use cases, such as industrial sensors, controllers, and wearables. Other use cases are not precluded. Another objective may be to study and evaluate low-power wake-up receiver architectures [RAN1, RAN4]. Yet another objective may be to study and evaluate wake-up signal designs to support wake-up receivers [RAN1, RAN4]. Another objective may be to study and evaluate L1 procedures and higher layer protocol changes that may be needed to support the wake-up signals [RAN2, RAN1]. Yet another objective may be to study potential UE power saving gains compared to the existing Rel-15/16/17 UE power saving mechanisms and their coverage availability, as well as latency impact. System impact, such as network power consumption, coexistence with non-low-power-WUR UEs, network coverage/capacity/resource overhead may have to be included in the study [RAN1]. The need for RAN2 evaluation may be triggered by RAN1 when necessary.

For more details on e.g., suggestions on WUR architecture and design, receiver power vs. sensitivity trade-off see e.g., RP-212005, RP-212254, RP-212367, and RP-212427 which were submitted to RAN3 #93-e.

The benefit of WUR may be understood to be to reduce the energy consumption of the receiver, such that unless there is any paging and data for the UE, it may remain in a power saving state. This may extend the battery life of the device, or alternatively enable shorter downlink latency, e.g., shorter DRX, at a fixed battery life. For short-range communication, the WUR power may be low enough, ~3 uW, that this may even, in combination with energy harvesting, enable that the WUR may be continuously on, that is, DRX or duty-cycling may be not used, without the need for a battery. This may be considered as a key enabler of battery-less devices towards 6G.

### IEEE WUR

In IEEE, the support for WUR has been specified to a greater extent than in 3GPP. That is, the focus was on low power WUR from the start, and the design may use WUR not only for receiving the WUS but also other control signals and signaling, such as synchronization and mobility information. This may be understood to allow the stations, corresponding to UEs in 3GPP, to only use the WUR when there may be no user-plane data transmission ongoing.

Similar to the 3GPP solution, the use of WUR may only be enabled in stations and not in access points (APs), that is, for downlink communication only. The AP may advertise that it has WUR operation capability, along with WUR configuration parameters, among other info, in which band/channel WUR may be operational, which may be different from the band/channel used for data transmission using the main receiver, e.g., WUR in 2.4 GHz band but data communication in 5 GHz band. Also, it may be noted that the WUR operating channel may be advertised in the legacy beacon, and that the WUR discovery operating channel may be different from the WUR operating channel. Stations may then request to be configured with WUR mode of operation. This request may have to be granted by the AP, and in case it is granted, the station may be further configured/setup for WUR mode of operation, that is, the configuration may be only valid for the connection to the associated AP, and further, the configuration may have to be torn down/de-configured if WUR is not to be used anymore. Both continuous WUR, that is, the receiver open all the time, and duty-cycled WUR, that is, receiver only open during preconfigured time slots, mode of operations may be supported. For the latter, the length of the duty-cycles and on-time during wake up may be part of the WUR configuration.

Unlike the 3GPP solution, the WUR operation mode may be understood to be a “sub-state” of the regular operation and upon the detection of a WUS transmission from the AP, the station may resume the power saving mechanism it may have been configured with before entering the WUR operation mode. That is, IEEE has specified a number of different power saving mechanisms, and for example if duty-cycled monitoring of the downlink has been configured for the station, it may switch to that upon detection of the WUS, unlike the specified 3GPP mechanism which may only cover paging, and the UE may continue to monitor PDCCH if WUS is detected. In this way, the IEEE WUR functionality may be understood to be more general, and may still allow for the station to, upon detection of WUS, “monitor paging” by checking in the beacon from the AP for which stations there is data, or for the station to directly respond with an uplink transmission.

A station receiving the IEEE WUS may be required to synchronize to the wireless medium prior to performing any transmissions, that is, using sync info in the beacon from the AP, typically transmitted every 100 ms, or from the transmission to another station. Synchronization to the wireless medium may be understood to refer to the following in IEEE 802.11; a station changing from sleep to awake in order to transmit may have to perform channel clear assessment until it may receive one or more frames that may allow it to correctly set the virtual carrier sensing. This may be understood to be to prevent collisions with transmissions from hidden nodes. In short, the virtual carrier sensing may tell a station to defer for a time period even if the wireless medium may appear to be idle, and may be set by receiving frames that may indicate the duration of an ongoing frame exchange. It may be noted that in WiFi technology and typically, one beacon transmission may be enough to sync for the station, that is, no need to acquire several transmissions due to poor coverage. Unlike operation in licensed bands, the station may also have to apply carrier sensing, and also possibly re-acquire channel sensing parameters, before uplink transmission.

The physical wake-up signal (WUS) in IEEE may contain complete frames which may have to be processed by the station. The drawback with this design may be understood to be that it may require more processing and handling and processing in the station, that is, compared to a simple WUR design, which may trigger one pre-defined activity in case WUS may be detected. The benefit may be that it may contain more information and the solution may be more general. The IEEE WUS may contain information to indicate if the WUS may be a WUR sync beacon, see below, a WUR discovery beacon, see below, or a regular WUS, intended to wake the station up. The WUS may also contain proprietary frames, which may e.g., be used to directly turn actuators on/off. The transmission may use on/off keying (OOK) modulation, using Manchester coding, but may be using multi-carrier OOK which may be generated by an Orthogonal Frequency Division Multiplexing (OFDM) transmitter, that is, WUR may be enabled as a software upgrade in APs. The WUS may be 4 MHz wide, but a whole 20 MHz channel may be reserved. The WUS may start with a 20 MHz legacy preamble, to allow other stations to perform carrier sense, followed by 4 MHz Manchester coded OOK. Two data rates may be supported: 62.5 kilobits per second (kbps) and 250 kbps, and link adaptation may be up to the AP, each packet may be self-contained and include the data rate, that is, in the WUR there may be two possible sync words used to signal the data rate.

The WUS may contain the following information: a) Station Identifier (ID), or group ID, grouping of stations may be supported, b) payload up to 22 bytes, c) short frames may contain only basic information; which WUR frame type+addressing, d) ordinary frames may contain control information, and in addition proprietary information, e) WUR beacons may contain Basic Service Set Identifier (BSS-ID), sync information, time counter, f) similar structure for WUS and WUR beacons, sync words may indicate the data rate, the station may then detect the header, from this, the station may tell if it is WUS or beacon, then check body, and g) WUR discovery frames may contain mobility related information to allow for lower power scan, see below.

Regarding mobility, both WUR sync beacons and WUR discovery beacons have been specified, which may only require the WUR to be used for reception, such that stations may stay in the WUR operation mode unless there is data transmission for the station. That is, stations may only need to switch back to legacy Power Saving Mode (PSM) upon WUS detection, or when moving to a new AP. WUR sync beacons may be used by stations to obtain rough synchronization, for data transmission the legacy beacon may be required to still be acquired, and WUR discovery beacons may be used to carry (legacy) mobility information to enable quick/low energy scanning, allowing stations, only using the WUR, to get information related to local and roaming scans for nearby APs, e.g., Service Set Identity (SSID) and main radio operating channels, if the channel quality should deteriorate.

That is, in the WUR discovery beacon, the AP may indicate one or more Basic Service Set (BSS), and the BSS-ID may have a one-to-one mapping with the assigned SSID name, in which WUR may be supported such that stations may not have to scan all frequencies/channels. Since the WUR discovery beacon may contain the legacy mobility information, there may be some duplication/redundancy in the broadcasted information. This may allow for low power scanning, using only the WUR. Note however that mobility in IEEE may be restricted to the same AP, and that hand-over between APs etc. may not be supported in the same way as in 3GPP. If a station in WUR operation mode moves to a new AP, it may have to move out of WUR operation mode and use the main receiver to obtain the beacon, sync, configuration, and associate to the new AP.

Energy Consumption Vs. Latency Trade-Off

Another important trade-off in WUR design and operation may be understood to be energy consumption versus latency. For example, to achieve a minimum latency, WUR may need to be always on to continuously monitor for downlink transmissions, e.g., WUS. The average power consumption may be reduced by relaxing latency and allowing the WUR to go to sleep modes.

In spite of the benefits of wake-up signals, existing methods to wake-up wireless devices may result in a waste of network resources, as well as energy resources.

### SUMMARY

As part of the development of embodiments herein, one or more challenges with the existing technology will first be identified and discussed.

WUR may be understood to have the biggest gain compared to baseline, that is, DRX, PEI, or eDRX, for use cases with strict downlink latency requirements, but where there may be understood to be seldom any data transmission to, or from, the UE. The UE may then keep the main receiver in an ultra-low sleep state for the majority of time and obtain energy consumption gains and much lower downlink latency compared to baseline.

Therefore, even though the original interest was to deploy WUR in Idle and Inactive states only, it has become increasingly interesting to deploy WUR in Connected state. The mechanism has, however, not been defined and configurational and triggering aspects may be understood to need to be solved.

According to the foregoing, it is an object of embodiments herein to improve the handling of a wake-up receiver.

According to a first aspect of embodiments herein, the object is achieved by a method, performed by a wireless device. The method is handling a wake-up receiver. The wireless device operates in a wireless communications network. The wireless device determines, while the wireless device is in connected mode, whether or not to activate a wake-up receiver. The determining is based on an expiration of a first timer. The wireless device then initiates activation, while the wireless device is in connected mode, of the wake-up receiver based on a result of the determination. The wireless device then monitors a downlink transmission with the activated wake-up receiver.

According to a second aspect of embodiments herein, the object is achieved by a method, performed by the network node. The method is for handling the wake-up receiver. The network node operates in the wireless communications network. The network node sends a second indication to the wireless device operating in the wireless communications network. The second indication indicates a configuration of usage or operation of the wake-up receiver in connected mode. The wake-up receiver is comprised in the wireless device. Whether or not to activate the wake-up receiver is based on an expiration of the first timer.

According to a third aspect of embodiments herein, the object is achieved by the wireless device, configured to perform the method. The wireless device may be understood to be for handling the wake-up receiver. The wireless device is configured to operate in the communications system. The wireless device is configured to determine, while the wireless device is in connected mode, whether or not to activate the wake-up receiver. The determining is configured to be based on the expiration of the first timer. The wireless device is also configured to initiate activation, while the wireless device is in connected mode, of the wake-up receiver based on the result of the determination. The wireless device is further configured to monitor the downlink transmission with the wake-up receiver configured to be activated.

According to a fourth aspect of embodiments herein, the object is achieved by the network node, configured to perform the method. The network node may be understood to be for handling the wake-up receiver. The network node is configured to operate in the communications system. The network node is configured to send the second indication to the wireless device configured to operate in the wireless communications network. The second indication is configured to indicate the configuration of usage or operation of the wake-up receiver in connected mode. The wake-up receiver is configured to be comprised in the wireless device. Whether or not to activate the wake-up receiver is configured to be based on the expiration of the first timer.

By the wireless device determining, while the wireless device is in connected mode, whether or not to activate the wake-up receiver, and then then initiating activation of the wake-up receiver and monitoring the downlink transmission with the activated wake-up receiver based on a result of the determination, the wireless device may enable to achieve UE energy savings and longer device battery life, also when in connected mode, or at a fixed energy consumption, the downlink latency may be reduced, there may be shorter Discontinued Reception (DRX)/duty-cycles, and more frequent checks for incoming transmissions. By the determination being based on the expiration of the first timer, the wireless device may also enable an efficient WUR operation in connected state to achieve power saving gain while ensuring latency constraints.

By the network node sending the second indication to the wireless device indicating the a configuration of usage or operation of the wake-up receiver in connected mode based on the expiration of the first timer, the network node may enable that the wireless device may achieve the benefits explained above.

### BRIEF DESCRIPTION OF THE DRAWINGS

Examples of embodiments herein are described in more detail with reference to the accompanying drawings, according to the following description.

FIG. 1 is a schematic diagram depicting an example of a location of a WUS and the paging occasion to which it is associated, according to existing methods.

FIG. 2 is a schematic diagram depicting an example of WUS for NB-IoT and LTE-M, according to existing methods.

FIG. 3 is a schematic diagram depicting an example of the use of eDRX and DRX WUS gaps for NB-IoT and LTE-M, according to existing methods.

FIG. 4 is a schematic diagram depicting an example of a wireless communications network, according to embodiments herein.

FIG. 5 is a flowchart depicting a method in a wireless device, according to embodiments herein.

FIG. 6 is a flowchart depicting a method in a network node, according to embodiments herein.

FIG. 7 is a schematic diagram illustrating a non-limiting example of a wireless device, according to some examples.

FIG. 8 is a schematic diagram illustrating a non-limiting example of methods disclosed herein, according to some examples.

FIG. 9 is a schematic diagram illustrating a non-limiting example of methods disclosed herein, according to some examples.

FIG. 10 is a schematic block diagram illustrating two embodiments, in panel a) and panel b), of a wireless device, according to embodiments herein.

FIG. 11 is a schematic block diagram illustrating two embodiments, in panel a) and panel b), of a network node, according to embodiments herein.

FIG. 12 is a flowchart depicting a method in a wireless device, according to examples related to embodiments herein.

FIG. 13 is a flowchart depicting a method in a network node, according to examples related to embodiments herein.

FIG. 14 is a schematic block diagram illustrating an example of a communication system 1400 in accordance with some embodiments.

FIG. 15 is a schematic block diagram illustrating a host 1500, which may be an embodiment of the host 1416 of FIG. 14, in accordance with various aspects described herein.

FIG. 16 shows a communication diagram of a host 1602 communicating via a network node 1604 with a UE 1606 over a partially wireless connection in accordance with some embodiments.

### DETAILED DESCRIPTION

Certain aspects of the present disclosure and their embodiments may provide solutions to these or other challenges. Embodiments herein may be generally understood relate to WUR operation in RRC_CONNECTED state and may contain triggering conditions and configurational aspects which may be needed for a proper working approach. Particularly, embodiments herein may relate to an approach with timers and triggers for WUR operation, and potentially replacing short connected mode discontinued reception (C-DRX) and/or C-DRX for UEs supporting WUR, configuration of duty-cycled WUR or continuous-WUR, that is, always-on, and the possibility to support another WUR operation, including a different main receiver sleep state, in Connected mode.

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

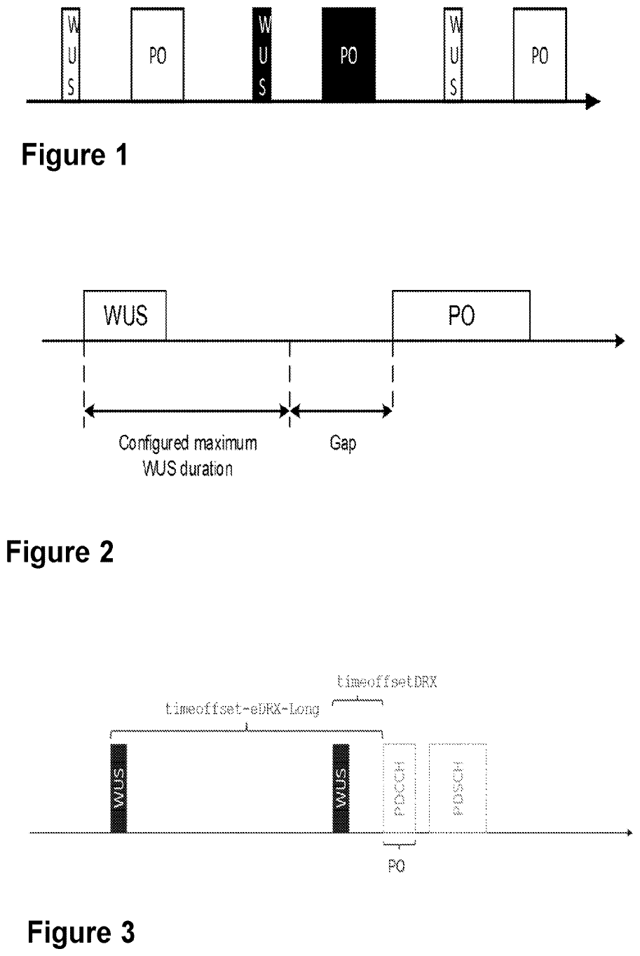

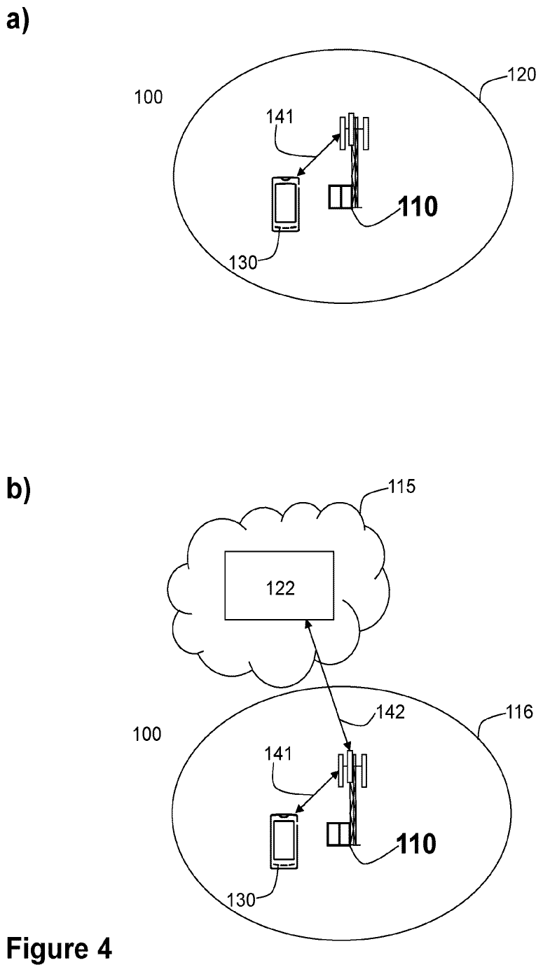

FIG. 1 depicts two non-limiting examples, in panel a) and panel b), respectively, of a wireless network or wireless communications network 100, sometimes also referred to as a wireless communications system, cellular radio system, or cellular network, in which embodiments herein may be implemented. The wireless communications network 100 may be a 5G system, 5G network, or Next Gen System or network. In other examples, the wireless communications network 100 may in addition, support other technologies such as, for example, Long-Term Evolution (LTE), e.g., LTE-M, LTE Frequency Division Duplex (FDD), LTE Time Division Duplex (TDD), LTE Half-Duplex Frequency Division Duplex (HD-FDD), LTE operating in an unlicensed band, such as LTE Licensed-Assisted Access (LAA), enhanced LAA (eLAA), further enhanced LAA (feLAA) and/or MulteFire. Yet in other examples, the wireless communications network 100 may further support other technologies such as, for example Wideband Code Division Multiple Access (WCDMA), Universal Terrestrial Radio Access (UTRA) TDD, Global System for Mobile communications (GSM) network, GSM/Enhanced Data Rates for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, WiFi networks, Worldwide Interoperability for Microwave Access (WiMax), or any cellular network or system.

The wireless communications network 100 may typically support MTC, enhanced MTC (eMTC), IoT and/or NB-IoT. Thus, although terminology from 5G/NR and LTE may be used in this disclosure to exemplify embodiments herein, this should not be seen as limiting the scope of the embodiments herein to only the aforementioned system.

The wireless communications network 100 may comprise a plurality of network nodes, whereof a network node 110 is depicted in the non-limiting example of FIG. 1. The network node 110 is a radio network node. That is, a transmission point such as a radio base station, for example a gNB, or any other network node with similar features capable of serving a user equipment, such as a wireless device or a machine type communication device, in the wireless communications network 100. In some examples, such as that depicted in FIG. 1b, the network node 110 may be a distributed node, and may partially perform its functions in collaboration with a virtual node in a cloud 115.

The wireless communications network 100 may cover a geographical area, which in some embodiments may be divided into cell areas, wherein each cell area may be served by a radio network node, although, one radio network node may serve one or several cells. In the example of FIG. 1, the network node 110 serves a cell 121. The network node 110 may be of different classes, such as, e.g., macro base station, home base station or pico base station, based on transmission power and thereby also cell size. In some examples, the network node 110 may serve receiving nodes with serving beams. The radio network node may support one or several communication technologies, and its name may depend on the technology and terminology used. Any of the radio network nodes that may be comprised in the communications network 100 may be directly connected to one or more core networks, e.g., to one or more network nodes in the one or more core networks, such as virtual network node 122. The virtual network node 122 may, for example be a core network node operating in the wireless communications network 100 and managing a user plane, such as, for example, a User Plane Function (UPF).

A plurality of wireless devices may be located in the wireless communication network 100, whereof a wireless device 130, is depicted in the non-limiting example of FIG. 1. The wireless device 130 comprised in the wireless communications network 100 may be a wireless communication device such as a 5G User Equipment (UE) or nUE, or a UE, which may also be known as e.g., mobile terminal, wireless terminal and/or mobile station, a mobile telephone, cellular telephone, or laptop with wireless capability, just to mention some further examples. The wireless device 130 may be, for example, portable, pocket-storable, hand-held, computer-comprised, or a vehicle-mounted mobile device, enabled to communicate voice and/or data, via the RAN, with another entity, such as a server, a laptop, a Personal Digital Assistant (PDA), or a tablet, Machine-to-Machine (M2M) device, a sensor, IoT device, NB-IoT device, device equipped with a wireless interface, such as a printer or a file storage device, modem, or any other radio network unit capable of communicating over a radio link in a communications system. The wireless device 130 comprised in the wireless communications network 100 may be enabled to communicate wirelessly in the wireless communications network 100. The communication may be performed e.g., via a RAN, and possibly the one or more core networks, which may be comprised within the wireless communications network 100.

The wireless device 130 may be configured to communicate within the wireless communications network 100 with the network node 110 over a first link 141, e.g., a radio link. The network node 110 may be configured to communicate within the wireless communications network 100 with the virtual network node 122 over a second link 142, e.g., a radio link or a wired link.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In general, the usage of “first”, “second”, “third”, “fourth” and/or “fifth” herein may be understood to be an arbitrary way to denote different elements or entities, and may be understood to not confer a cumulative or chronological character to the nouns they modify, unless otherwise noted, based on context.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments.

More specifically, the following are embodiments related to a wireless device, such as the wireless device 130, e.g., a 5G UE, nUE or a UE, and embodiments related to a network node, such as the network node 110, e.g., a gNB.

Some embodiments herein will now be further described with some non-limiting examples, which may be combined with the embodiments just described.

In the following description, any reference to a/the UE, or simply “UE” may be understood to equally refer the wireless device 130; any reference to a/the gNB and/or a/the network may be understood to equally refer to the network node 110.

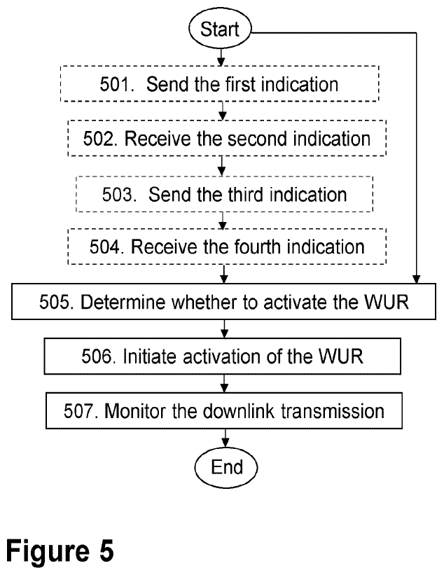

Embodiments of a method, performed by a wireless device, such as the wireless device 130, will now be described with reference to the flowchart depicted in FIG. 5. The method may be understood to be for handling a wake-up receiver. The wireless device 130 operates in a wireless communications network, such as the wireless communications network 100. The method may be understood to be computer-implemented.

In some embodiments, the wireless communications network 100 may support New Radio (NR).

Several embodiments are comprised herein. The method may comprise three or more of the following actions. In some embodiments, all the actions may be performed. It should be noted that the examples herein may be not mutually exclusive. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the wireless device 130 is depicted in FIG. 5. In FIG. 5 optional actions in some embodiments may be represented with dashed lines. In some embodiments, the actions may be performed in a different order than that depicted FIG. 5.

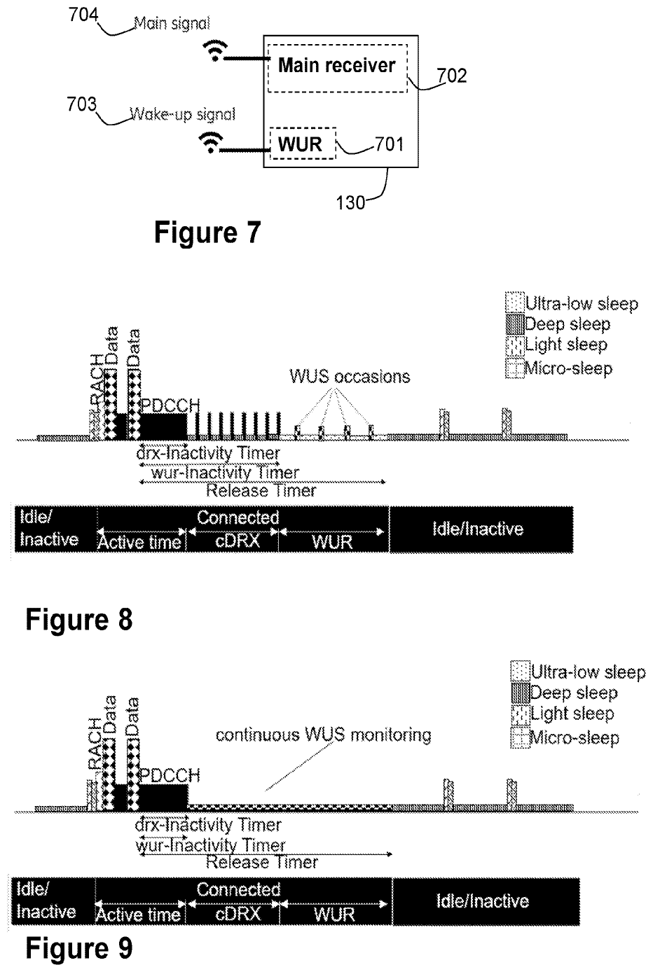

As background, a dedicated wake up radio (WUR) may be used for monitoring a wake-up signal (WUS). Once a WUR may detect the intended WUS, it may wake up the main baseband/Radio Frequency (RF)/less power efficient, receiver to detect further incoming messages, as will be shown later in FIG. 7. Therefore, the main receiver may go to sleep mode and save power until it may be triggered by WUR. In order to exploit the benefits of WUR/WUS in various use cases, it may be understood to be important to efficiently support WUR/WUS in different RRC states including RRC_CONNECTED.

Embodiments herein may be understood to provide an approach for WUR procedure and configuration for use in RRC_CONNECTED state.

### Action 501

In this Action 501, the wireless device 130 may send a first indication.

The sending in this Action 501 may be to the network node 110 operating in the wireless communications network 100.

The sending in this Action 501 may be, e.g., transmitting, and may be performed, e.g., via the first link 141.

The first indication may indicate a capability of operation of a wake-up receiver. The wake-up may be understood to be of or comprised in the wireless device 130.

By the wireless device 130 sending the first indication to the network node 110 in this Action 501, the wireless device 130 may enable the network node 110 to know that it may configure the wireless device 130 for usage of the wake-up receiver, as described in the next Action 502.

### Action 502

Embodiments herein may be understood to relate to enabling WUR operation in RRC_CONNECTED state as a new scheme for monitoring of the downlink, introduced in addition to the existing ones: continuous PDCCH monitoring, short C-DRX, and long C-DRX. WUR operation in connected mode, e.g., RRC_CONNECTED state, may be referred to WUR Connected procedure.

In this Action 502, the wireless device 130 may receive a second indication. The receiving in this Action 502 may be from the network node 110.

The receiving in this Action 501 may be performed, e.g., via the first link 141.

The second indication may indicate a configuration of usage or operation of the wake-up receiver in connected mode. The connected mode may be an RRC Connected mode. That is, the second indication may indicate the configuration to control when WUR may have to be used in Connected state. The configuration may be configured to configure the wireless device 130 to determine, while the wireless device 130 may be in connected mode, whether or not to activate the wake-up receiver, based on the expiration of the first timer.

In some embodiments, the second indication may indicate at least one of the following options.

According to a first option, the second indication may indicate an on/off configuration. That is, WUR configuration on/off, e.g., semi-static.

According to a second option, the second indication may indicate one or more properties of a first timer. The wireless device 130 may determine to activate the wake-up receiver after expiration of the first timer. WUR operation in Connected, for a UE indicating it is capable of WUR operation, such as the wireless device 130 may have done in Action 501, may, for example, be triggered at the expiration of the first timer. The first timer may be referred to herein as WUR inactivity timer, e.g., WUR-inactivityTimer. The first timer, in some examples of embodiments herein, may be a separately configured WUR inactivity timer, e.g., WUR-inactivity Timer. In some examples, the first timer may be separately configured from a second timer. The second timer may be a cDRX timer. The first time may indicate when the wireless device 130 may have to switch from legacy C-DRX operation to WUR operation. This first timer may, e.g., be started at the same time as the legacy drx-InactivityTimer, or be started at the expiration of the legacy drx-InactivityTimer. In the latter case, the wireless device 130 may, upon data inactivity, first monitor using legacy C-DRX, and then later switch to WUR operation. This may also be possible in the former case if WUR-inactivityTimer>drx-Inactivity Timer, but this case WUR-inactivityTimer<drx-Inactivity Timer may also be configured such that the wireless device 130 may go directly to WUR operation.

In some embodiments, first start and restart conditions of the first timer may be the same as second start and restart conditions of the second timer. In particular examples, the start and re-start conditions for the WUR-inactivity Timer may be the same as for the legacy drx-Inactivity Timer.

According to a third option, the second indication may indicate a length of a duty cycle of the wake-up receiver. That is, the second indication may indicate WUR duty-cycle length, e.g., WUR-DrxCycle, in case of duty-cycled WUR operation.

In another case, the wireless device 130 may be configured to monitor WUS with the WUR continuously, that is, always-on WUR. This may be achieved by configuring the wireless device 130 with always-on operation which may be triggered either at the expiration of the new first timer, that is, the WUR inactivity timer WUR-inactivityTimer, or alternatively, the wireless device 130 may be configured such that WUR operation may replace current C-DRX operation. That is, the legacy trigger drx-Inactivity Timer may be reused.

In accordance with the foregoing, according to a fourth option, the second indication may indicate a first parameter indicating the second timer is reused for the wake-up receiver. The first parameter may be understood as a configuration parameter stating that the legacy C-DRX cycle may be reused for WUR, e.g., for short-DRX and/or long-DRX.

According to a fifth option, the second indication may indicate a further indication indicating whether always-on wake-up receiver or duty-cycled wake-up receiver is to be used. The further indication may be understood, for example, as an indication of whether Always-On WUR or duty-cycled WUR may have to be used.

According to a sixth option, the second indication may indicate a third timer to switch from always-on wake-up receiver and duty-cycled wake-up receiver. The third timer may be understood, for example, as an inactivity timer from switching between Always-On WUR and duty-cycled WUR operation. For example, the energy consumption for Always-On WUR may likely be higher than that for duty-cycled WUR, but the DL latency may be shorter. Therefore, after data activity may have stopped, the network node 110 may want to configure the wireless device 130 with Always-On WUR just after the inactivity, e.g., replacing short-DRX, and then, at the expiration of this new WUR inactivity timer, always-onWUR-inactivityTimer, the wireless device 130 may switch to duty-cycled WUR operation.

According to a seventh option, the second indication may indicate a power state to be used by the main receiver of the wireless device 130. For example, the seventh option may be an indication on which power state the main radio may have to select for WUR operations, given different latency requirements or Quality of Service (QoS) profile.

The main radio receiver of the wireless device 130 may be configured to operate with a plurality of sleep modes during operation of the wake-up receiver. That is, during the WUR operation, the main radio may be in different sleep modes for power saving. The plurality of sleep modes may comprise at least one of: an ultra-low sleep mode, a light sleep mode, a deep sleep mode and a micro-sleep mode. It may be noted that there may be a trade-off between power consumption and latency. Specifically, a deeper sleep mode may be understood to consume lower energy, but the main radio may require longer transition time and energy to wake up. Therefore, the sleep modes of the main radio may be configurable which may be understood to make the operation more flexible for different use cases. For example, the main radio may be in ultra-low sleep mode, light sleep mode, or any other sleep mode suitable for the operation. In a related example, a new sleep mode may be introduced for the main radio when using WUR in the connected state. An example of a new sleep mode may be a mode in-between the deep sleep and light sleep with a new sleep power and transition energy, and shorter transition time compared to the sleep state in Idle/Inactive to motive the use in Connected.

In another example, there may be a dependence between WUR operation and the main radio sleep mode, which may include power level and transition time from sleep to active state. In accordance with the foregoing, in embodiments herein, the sleep mode may be configured to be chosen for operation based on a type of wake-up radio operation. The type of wake-up radio operation may be one of: always-on and duty-cycled wake-up radio operation. For instance, the main radio sleep mode may be different for always-on WUR and duty-cycled WUR operations. Additionally, in case of duty-cycled WUR, the main radio sleep mode may depend on the WUR duty cycle parameters. cDRX operation may be one of long and short. In some embodiments, the wireless device 130 may be configured to determine to activate the wake-up receiver after expiration of the first timer and may refrain from monitoring downlink transmission with cDRX during a second period of time, wherein the cDRX may be long.

According to an eighth option, the second indication may indicate a fourth timer to switch from duty-cycled wake-up receiver operations. For example, the fourth timer may be an inactivity timer for switching between different duty-cycled WUR operations. In principle, WUR may operate in different duty-cycled modes with different parameters. For example, short WUR duty cycle and long WUR duty cycle may be defined considering WUR power consumption and latency trade-off. In this case, after expiration of the WUR inactivity timer of short DRX cycle, the wireless device 130 may switch to long duty cycle operation.

According to a ninth option, the second indication may indicate a time gap between a wake-up signal occasion and start of a search space of a physical downlink control channel. For example, the second indication may indicate a time gap between the WUS occasion and start of the PDCCH search space, in case WUS is detected.

According to a tenth option, the second indication may indicate wake-up receiver resources to be monitored by the wireless device 130. For example, the second indication may indicate WUR resources to be monitored, including a) WUR occasion, e.g., time- and frequency-resources, timing start offset, duration, b) WUR sequence and c) WUR UE group.

According to an eleventh option, the second indication may indicate a configuration of control signalling for enabling and/or disabling operation of wake-up signal. For example, the second indication may indicate a configuration of any dynamic control signaling for enabling/disabling WUS operation, e.g., indication in Downlink Control Information (DCI), Medium Access Control (MAC) Control Element (CE), for enabling WUR operation, or in WUS, for disabling WUR operation, e.g., a specific WUS sequence or a WUS is a specific time- and frequency resource.

In some embodiments, the second indication may indicate a second parameter indicating operation with the wake-up receiver replaces monitoring with long or short DRX. The second parameter may be understood to be a configuration parameter stating that WUR operation may be replacing either short-DRX or long-DRX monitoring, or both. This may contain a mapping of the use of WUR to existing use of long-DRX and short-DRX in Connected mode. For example, that WUR may be not used for short-DRX but for long-DRX, such that at the expiration of the legacy drx-InactivityTimer, the wireless device 130 may monitor short-DRX as in legacy operation, but when later the drx-ShortCycle Timer may expire, the wireless device 130 may not start monitoring long-DRX as in legacy operation, but instead monitor the DL using WUR, e.g., reusing the long-DRX cycle.

In one example, where WUR operation may be replacing long C-DRX, but not short C-DRX, this may be implemented as follows in TS 38.321, wherein the additions are underlined and in bold font:

1> if drx-InactivityTimer for a DRX group expires:

| 2> | if the Short DRX cycle is configured: | |
|---|---|---|
| | 3> | start or restart drx-ShortCycleTimer for this DRX group in the first symbol after |
| | | the expiry of drx-InactivityTimer, |
| | 3> | use the Short DRX cycle for this DRX group. |
| 2> | else: | |
| | 3> | if WUR is configured |
| | | 4> use WUR for monitoring the DL with the |
| | | the WUR DRX cycle configured |
| | 3> | else |
| | | 4> use the Long DRX cycle for this DRX group. |

In another example where, instead, the WUR-inactivityTimer may be used, it may be implemented as follows in TS 38.321, wherein the additions are underlined and in bold font:

1> if WUR-inactivityTimer for a DRX group expires:

| | |
|---|---|
| 2> | if the always-on WUR is configured: |
| | 3> start monitoring the configured WUS resources continuously; |
| 2> | else: |
| | 3> use duty-cycled WUR with the configured DRX cycle. |

It may be noted that during WUR operation, the wireless device 130 may be understood to not be obliged to monitor PDCCH with its main receiver.

In some embodiments, at least one of the following may apply.

### DRX-Config Configuration

In some embodiments, the second indication may be comprised in an extension of a DRX configuration information element.

In one alternative, the WUR configuration for use in RRC_CONNECTED may be introduced as an extension to the DRX-Config. An ASN.1 example of this, just the WUR inactivity timer and WUR duty-cycle to keep it clean, is given below, where additions are highlighted in bold, strike-through font.

DRX-Config information element

-- ASN1START
-- TAG-DRX-CONFIG-START

| | |
|---|---|
| DRX-Config ::= | SEQUENCE { |
| drx-onDurationTimer | CHOICE { |
| | subMilliseconds INTEGER (1..31), |
| | milliSeconds ENUMERATED { |
| | ms1, ms2, ms3, ms4, ms5, ms6, ms8, ms10, ms20, ms30, ms40, ms50, ms60, |
| | ms80, ms100, ms200, ms300, ms400, ms500, ms600, ms800, ms1000, ms1200, |
| | ms1600, spare8, spare7, spare6, spare5, spare4, spare3, spare2, spare1 } |
| | }, |
| drx-InactivityTimer | ENUMERATED { |
| | ms0, ms1, ms2, ms3, ms4, ms5, ms6, ms8, ms10, ms20, ms30, ms40, ms50, ms60, ms80, |
| | ms100, ms200, ms300, ms500, ms750, ms1280, ms1920, ms2560, spare9, spare8, |
| | spare7, spare6, spare5, spare4, spare3, spare2, spare1}, |
| drx-HARQ-RTT-TimerDL | INTEGER (0..56), |
| drx-HARQ-RTT-TimerUL | INTEGER (0..56), |
| drx-RetransmissionTimerDL | ENUMERATED { |
| | sl0, sl1, sl2, sl4, sl6, sl8, sl16, sl24, sl33, sl40, sl64, sl80, sl96, sl112, sl128, |
| | sl160, sl320, spare15 spare14, spare13, spare12, spare11, spare10, spare9, |
| | spare8, spare7, spare6, spare5, spare4, spare3, spare2, spare1}, |
| drx-RetransmissionTimerUL | ENUMERATED { |
| | sl0, sl1, sl2, sl4, sl6, sl8, sl16, sl24, sl33, sl40, sl64, sl80, sl96, sl112, sl128, |
| | sl160, sl320, spare15, spare14, spare13, spare12, spare11, spare10, spare9, |
| | spare8, spare7, spare6, spare5, spare4, spare3, spare2, spare1 }, |
| drx-LongCycleStartOffset | CHOICE { |
| ms10 | INTEGER (0..9), |
| ms20 | INTEGER (0..19), |
| ms32 | INTEGER (0..31), |
| ms40 | INTEGER (0..39), |
| ms60 | INTEGER (0..59), |
| ms64 | INTEGER (0..63), |
| ms70 | INTEGER (0..69), |
| ms80 | INTEGER (0..79), |
| ms128 | INTEGER (0..127), |
| ms160 | INTEGER (0..159), |
| ms256 | INTEGER (0..255), |
| ms320 | INTEGER (0..319), |
| ms512 | INTEGER (0..511), |
| ms640 | INTEGER (0..639), |
| ms1024 | INTEGER (0..1023), |
| ms1280 | INTEGER (0..1279), |
| ms2048 | INTEGER (0..2047), |
| ms2560 | INTEGER (0..2559), |
| ms5120 | INTEGER (0..5119), |
| ms10240 | INTEGER (0..10239) |

},

| | |
|---|---|
| shortDRX | SEQUENCE { |
| drx-ShortCycle | ENUMERATED { |
| | ms2, ms3, ms4, ms5, ms6, ms8, ms10, ms14, ms16, ms20, ms30, ms32, |
| | ms35, ms40, ms64, ms80, ms128, ms160, ms256, ms320, ms512, ms640, spare9, |
| | spare8, spare7, spare6, spare5, spare4, spare3, spare2, spare1 }, |
| drx-ShortCycleTimer | INTEGER (0..16) |

| | |
|---|---|
| } | OPTIONAL, -- |

Need R

| | |
|---|---|
| drx-SlotOffset | INTEGER (0..31) |

}

| | |
|---|---|
| DRX-ConfigExt-v1700 ::= | SEQUENCE { |
| drx-HARQ-RTT-TimerDL-r17 | INTEGER (0..448), |
| drx-HARQ-RTT-TimerUL-r17 | INTEGER (0..448) |

}

| | |
|---|---|
| WUR-Config-v18xy ::= | SEQUENCE { |
| WUR-InactivityTimer-r18 | ENUMERATED { |
| | ms0, ms1, ms2, ms3, ms4, ms5, ms6, ms8, ms10, ms20, ms30, ms40, ms50, ms60, ms80, |
| | ms100, ms200, ms300, ms500, ms750, ms1280, ms1920, ms2560, spare9, spare8, |
| | spare7, spare6, spare5, spare4, spare3, spare2, spare1} OPTIONAL, |
| WUR-DrxCycle-r18 | ENUMERATED { |
| | ms640, ms1024, ms1280, ms2048, ms2560, ms5120, ms10240, spare1} OPTIONAL |

}
-- TAG-DRX-CONFIG-STOP
-- ASN1STOP

### PhysicalCellGroupConfig Configuration

In some embodiments, the second indication may be comprised in an extension of a Physical Cell Group configuration information element.

In one alternative, the WUR configuration for use in RRC_CONNECTED may be introduced as an extension to the PhysicalCellGroupConfig. An ASN.1 example of this, just the WUR inactivity timer and WUR duty-cycle to keep it clean, is given below, where additions are highlighted in bold, strike-through font.

PhysicalCellGroupConfig information element

-- ASN1START
-- TAG-PHYSICALCELLGROUPCONFIG-START

| PhysicalCellGroupConfig ::= | SEQUENCE { | |
|---|---|---|
| harq-ACK-SpatialBundlingPUCCH | ENUMERATED {true} | OPTIONAL, -- Need S |
| harq-ACK-SpatialBundlingPUSCH | ENUMERATED {true} | OPTIONAL, -- Need S |
| p-NR-FR1 | P-Max | OPTIONAL, -- Need R |
| pdsch-HARQ-ACK-Codebook | ENUMERATED {semiStatic, dynamic}, | |
| tpc-SRS-RNTI | RNTI-Value | OPTIONAL, -- Need R |
| tpc-PUCCH-RNTI | RNTI-Value | OPTIONAL, -- Need R |
| tpc-PUSCH-RNTI | RNTI-Value | OPTIONAL, -- Need R |
| sp-CSI-RNTI | RNTI-Value | OPTIONAL, -- Need R |
| cs-RNTI | SetupRelease { RNTI-Value } | OPTIONAL, -- Need M |

```
  ...,
  [[
[Text omitted}
```

| | | |
|---|---|---|
| prioLowDG-HighCG-r17 | ENUMERATED {enabled} | OPTIONAL, -- Need R |
| prioHighDG-LowCG-r17 | ENUMERATED {enabled} | OPTIONAL, -- Need R |
| twoQCLTypeDforPDCCHRepetition-r17 | ENUMERATED {enabled} | OPTIONAL, -- Need R |
| multicastConfig-r17 | SetupRelease { MulticastConfig-r17 } | OPTIONAL, -- Need M |
| pdcch-BlindDetectionCA- | SetupRelease { PDCCH- | OPTIONAL, -- Need M |
| CombIndicator-r17 | BlindDetectionCA-CombIndicator-r17 } | |

```
  ]],
  [[
```

| | | |
|---|---|---|
| simultaneousSR-PUSCH-diffPUCCH- | ENUMERATED {enabled} | OPTIONAL, -- Cond |
| Groups-r17 | | twoPUCCHgroup |

```
  ]],
  [[
```

| | | |
|---|---|---|
| wur-Config-r18 | SetupRelease { WUR-Config-r18 } | OPTIONAL, --Need M |

]]
}

| | |
|---|---|
| PDSCH-HARD-ACK-EnhType3-r17 ::= | SEQUENCE { |
| pdsch-HARQ-ACK-EnhType3Index-r17 | PDSCH-HARQ-ACK-EnhType3Index-r17, |

applicable-r17 CHOICE {

| | |
|---|---|
| perCC | SEQUENCE (SIZE (1..maxNrofServingCells)) OF INTEGER (0..1), |
| perHARQ | SEQUENCE (SIZE (1..maxNrofServingCells)) OF BIT STRING (SIZE (16)) |

},

| | | |
|---|---|---|
| pdsch-HARQ-ACK-EnhType3NDI-r17 | ENUMERATED {true} | OPTIONAL, -- Need R |
| pdsch-HARQ-ACK-EnhType3CBG-r17 | ENUMERATED {true} | OPTIONAL, -- Need S |

...
}
[Text omitted}

| PDCCH-BlindDetectionCA-CombIndicator- | SEQUENCE { | |
|---|---|---|
| r17 ::= | | |
| pdcch-BlindDetectionCA1-r17 | INTEGER (1..15) | OPTIONAL, -- Need R |
| pdcch-BlindDetectionCA2-r17 | INTEGER (1..15) | OPTIONAL, -- Need R |

| | |
|---|---|
| pdcch-BlindDetectionCA3-r17 | INTEGER (1..15) |

}

| WUR-Config-r18 ::= | SEQUENCE { | |
|---|---|---|
| WUR-InactivityTimer-r18 | ENUMERATED { | |
| | ms0, ms1, ms2, ms3, ms4, ms5, ms6, ms8, ms10, ms20, ms30, ms40, ms50, ms60, ms80, | |
| | ms100, ms200, ms300, ms500, ms750, ms1280, ms1920, ms2560, spare9, spare8, | |
| | spare7, spare6, spare5, spare4, | OPTIONAL, |
| | spare3, spare2, spare1} | |
| WUR-DrxCycle-r18 | ENUMERATED { | |
| | ms640, ms1024, ms1280, ms2048, | OPTIONAL |
| | ms2560, ms5120, ms10240, spare1} | |

}
-- TAG-PHYSICALCELLGROUPCONFIG-STOP
-- ASN1STOP

By the wireless device 130 receiving the second indication indicating the configuration of usage or operation of the wake-up receiver in connected mode in this Action 502, the wireless device 130 may be enabled to then use the wake-up receiver in connected mode and thereby be enabled to achieve UE energy savings and longer device battery life, also when in connected mode, or at a fixed energy consumption, the downlink latency may be reduced, shorter Discontinued Reception (DRX)/duty-cycles, and more frequent checks for incoming transmissions. By the configuration configuring the wireless device 130 to determine whether or not to activate the wake-up receiver based on the expiration of the first timer, the wireless device 130 may be also enabled to use an efficient WUR operation in connected state to achieve power saving gain while ensuring latency constraints.

### Action 503

In some embodiments, in this Action 503, the wireless device 130 may send a third indication.

The sending in this Action 503 may be to the network node 110.

The sending in this Action 503 may be, e.g., transmitting, and may be performed, e.g., via the first link 141.

The third indication may indicate a wish to be kept in connected mode with the wake-up receiver. The wish may be understood to be of the wireless device 130.

In some embodiments, the third indication may be comprised in a UE assistance information message.

In some embodiments, the wireless device 130 may indicate a preference for a configuration of the wake-up receiver in UE assistance information. In one case, new assistance information may be introduced for the wireless device 130 to indicate that it wishes to be kept in RRC_CONNECTED with WUR, see configuration below.

### UE Assistance Information

In one example, the wireless device 130 may indicate its preference for the WUR configuration in RRC_CONNECTED. For example, the wireless device 130 may indicate if it wishes to use WUR in Connected at all, perhaps the wireless device 130 capability may be common and it may be supported in the wireless device 130 for use in Idle and Inactive, a suggested value for the WURinactivityTimer, preferred use of continuous-WUR or duty-cycled WUR if the wireless device 130 is capable of both, etc. An ASN.1 example of this is given below, where additions are highlighted in bold, strike-through font.

UEAssistanceInformation message

-- ASN1START
-- TAG-UEASSISTANCEINFORMATION-START

| | |
|---|---|
| UEAssistanceInformation ::= | SEQUENCE { |
| criticalExtensions | CHOICE { |
| ueAssistanceInformation | UEAssistanceInformation-IEs, |
| criticalExtensionsFuture | SEQUENCE { } |

}
}

| UEAssistanceInformation-IEs ::= | SEQUENCE { | |
|---|---|---|
| delayBudgetReport | DelayBudgetReport | OPTIONAL, |
| lateNonCriticalExtension | OCTET STRING | OPTIONAL, |
| nonCriticalExtension | UEAssistanceInformation-v1540-IEs | OPTIONAL |

}
[Text omitted]

| UEAssistanceInformation-v1700-IEs ::= | SEQUENCE { | |
|---|---|---|
| ul-GapFR2-Preference-r17 | UL-GapFR2-Preference-r17 | OPTIONAL, |
| musim-Assistance-r17 | MUSIM-Assistance-r17 | OPTIONAL, |
| overheatingAssistance-r17 | OverheatingAssistance-r17 | OPTIONAL, |
| maxBW-PreferenceFR2-2-r17 | MaxBW-PreferenceFR2-2-r17 | OPTIONAL, |
| maxMIMO-LayerPreferenceFR2-2-r17 | MaxMIMO-LayerPreferenceFR2-2-r17 | OPTIONAL, |
| minSchedulingOffsetPreferenceExt-r17 | MinSchedulingOffsetPreferenceExt-r17 | OPTIONAL, |
| rlm-MeasRelaxationState-r17 | BOOLEAN | OPTIONAL, |
| bfd-MeasRelaxationState-r17 | BIT STRING (SIZE (1..maxNrofServingcells)) | OPTIONAL, |
| nonSDT-DataIndication-r17 | SEQUENCE { | |
| resumeCause-r17 | ResumeCause | OPTIONAL |
| } | | OPTIONAL, |
| scg-DeactivationPreference | ENUMERATED { scgDeactivationPreferred, noPreference } | OPTIONAL, |
| uplinkData-r17 | ENUMERATED { true } | OPTIONAL, |
| rrm-MeasRelaxationFulfilment-r17 | BOOLEAN | OPTIONAL, |
| propagationDelayDifference-r17 | PropagationDelayDifference-r17 | OPTIONAL, |
| nonCriticalExtension | UEAssistanceInformation-v18xy-IEs | OPTIONAL |

}

| UEAssistanceInformation-v18xy-IEs ::= | SEQUENCE { | |
|---|---|---|
| wur-Preference-r18 | WUR-Preference-r16 | OPTIONAL, |
| noncriticalExtension | SEQUENCE { } | OPTIONAL |

}

| IDC-Assistance-r16 ::= | SEQUENCE { | |
|---|---|---|
| affectedCarrierFreqList-r16 | AffectedCarrierFreqList-r16 | OPTIONAL, |
| affectedCarrierFreqCombList-r16 | AffectedCarrierFreqCombList-r16 | OPTIONAL, |

...
}
[Text omitted]

| UL-GapFR2-Preference-r17 ::= | SEQUENCE { | |
|---|---|---|
| ul-GapFR2-PatternPreference-r17 | INTEGER (0..3) | OPTIONAL |

}

| | |
|---|---|
| PropagationDelayDifference-r17 ::= | SEQUENCE (SIZE (1..4)) OF INTEGER (−270..270) |
| WUR-Preference-r18 ::= | SEQUENCE { |
| preferredWUR-InactivityTimer-r18 | ENUMERATED { |
| | ms0, ms1, ms2, ms3, ms4, ms5, ms6, ms8, ms10, ms20, ms30, ms40, ms50, ms60, ms80, |
| | ms100, ms200, ms300, ms500, ms750, ms1280, ms1920, ms2560, spare9, spare8, |
| | spare7, spare6, spare5, spare4, spare3, spare2, spare1} OPTIONAL, |
| preferredWUR-DrxCycle-r18 | ENUMERATED { |
| | ms640, ms1024, ms1280, ms2048, ms2560, ms5120, ms10240, spare1} OPTIONAL |

}
-- TAG-UEASSISTANCEINFORMATION-STOP
-- ASN1STOP

Another parameter which may be added may be whether the wireless device 130 may like to reside in RRC_CONNECTED for extended periods of time with the use of WUR before being released to Idle/Inactive state.

By the wireless device 130 sending the third indication to the network node 110 indicating the preference for the configuration of the wake-up receiver in UE assistance information, the wireless device 130 may be enabled to, for example, adapt the configuration it may receive to its capabilities and/or level of stored energy to optimize its consumption.

### Action 504

In this Action 504, the wireless device 130 may receive a fourth indication.

The receiving in this Action 504 may be from the network node 110.

The receiving in this Action 504 may be performed, e.g., via the first link 141.

The fourth indication may indicate an instruction to remain in connected mode with the wake-up receiver.

### Extended Stay in Connected State

In one example, the network node 110 may keep the wireless device 130 configured with WUR operation in RRC_CONNECTED for a longer time than UEs not capable of WUR, or a UE not configured with WUR. That is, the start-up time of the main receiver of the wireless device 130, which may be relatively long, e.g. ~1s, may have been used as an argument as to why WUR operation in RRC_IDLE or RRC_INACTIVE may have to mainly be relevant. However, WUR operation may enable UEs such as the wireless device 130 to be kept in RRC_CONNECTED much longer time. For example, if the network node 110 knows the wireless device 130 supports WUR, it may configure it with WUR operation and keep the wireless device 130 in RRC_CONNECTED for extended periods of time, even up to several minutes. Since the wireless device 130 may benefit from reduced energy consumption from WUR, there may be understood to be no drawback for the wireless device 130 not to be released to RRC_IDLE or RRC_INACTIVE. There may however be gains for the wireless device 130 in terms of reduced latency for any upcoming data transmission. That is, due to the omitted RRC connection establishment, or resumption, since the wireless device 130 may already be in RRC_CONNECTED. This example may mainly be up to network implementation, but certain aspects may be captured in specification to make it work better.

### Action 505

In this Action 505, the wireless device 130 determines whether or not to activate the wake-up receiver. As stated earlier, the wake-up may be understood to be of, or comprised in, the wireless device 130.

The determining in this Action 505 is performed while the wireless device 130 is in connected mode, e.g., RRC Connected mode.

The determining in this Action 505 is based on an expiration of the first timer.

Determining in this Action 505 may comprise deciding, calculating or checking or similar.

In some embodiments, at least one of the following options may apply. According to a first option, as stated earlier, the first timer may be separately configured from the second timer; the second timer may be the connected mode discontinued reception (cDRX) timer. According to a second option, the wireless device 130 may determine to activate the wake-up receiver after expiration of the first timer. According to a third option, the wireless device 130 may determine to activate the wake-up receiver after expiration of the first timer and after monitoring downlink transmission with cDRX during a first period of time. According to a fourth option, cDRX operation may be one of long and short.

The separately configured timer may be the WUR-inactivity timer.

In some embodiments, at least one of the following may apply. According to a first option, the first timer may be used instead of the second timer. According to a second option, the wireless device 130 may determine to activate the wake-up receiver after expiration of the first timer and may refrain from monitoring downlink transmission with cDRX during a second period of time. According to a third option, the expiration of the first timer may trigger an always-on or continuous operation of the wake-up receiver. According to a fourth option, cDRX operation may be one of long and short. According to a fifth option, the wireless device 130 may determine to activate the wake-up receiver after expiration of the first timer and may refrain from monitoring downlink transmission with cDRX during a second period of time; In such examples, the cDRX may be long. According to a sixth option, the wireless device 130 may determine to activate the wake-up receiver after expiration of the first timer and may refrain from monitoring downlink transmission with cDRX during a second period of time; In such examples, the cDRX may be short.

By the wireless device 130 determining in this Action 504, while the wireless device 130 is in connected mode, whether or not to activate the wake-up receiver, the wireless device 130 may be enabled to achieve UE energy savings and longer device battery life, also when in connected mode, or at a fixed energy consumption, the downlink latency may be reduced, there may be shorter Discontinued Reception (DRX)/duty-cycles, and more frequent checks for incoming transmissions. By the determination being based on the expiration of the first timer, the wireless device 130 may also enable an efficient WUR operation in connected state to achieve power saving gain while ensuring latency constraints.

### Action 506

In this Action 506, the wireless device 130 initiates activation, while the wireless device 130 is in connected mode, of the wake-up receiver. The initiating activation of the wake-up receiver is based on a result of the determination.

Initiating may be understood as triggering, enabling, facilitating or starting.

The activation of the wake-up receiver may be understood as a procedure to wake-up the wake-up receiver. The expression to wake-up the wake-up receiver may be understood in context that, a main radio receiver of the wireless device 130 may be configured to be in a sleep mode during wake-up receiver operation. That is, the main receiver, the associated baseband processing, and other components but the WUR may be put in a deep sleep state. While in WUR operation, these components in the deep sleep state may be started up upon detection of a WUS.

The activation of the wake-up receiver may be to monitor a downlink wake-up signal.

By, in this Action 506, initiating activation of the wake-up receiver while in connected mode based on a result of the determination performed in Action 505, the wireless device 130 may be understood to enable to achieve the benefits described above for Action 505.

### Action 507

After the expiration of a WUR-specific timer, that is, the first timer, which may be referred to herein as WUR-inactivityTimer, the wireless device 130 may start monitoring the DL with WUR operation.

In this Action 507, the wireless device 130 monitors a downlink transmission.

The monitoring of the downlink transmission is with the activated wake-up receiver.

By in this Action 507 monitoring the downlink transmission with the activated wake-up receiver, the wireless device 130 the wireless device 130 may be understood to enable to achieve the benefits described above for Action 505.

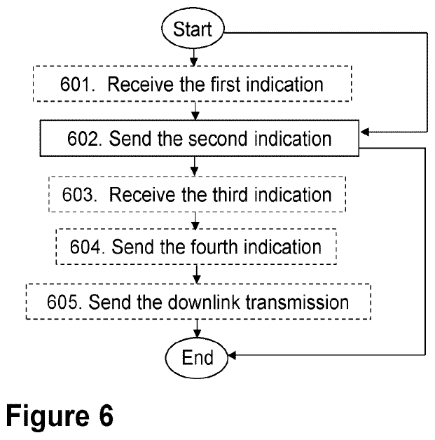

Embodiments of a method, performed by a network node, such as the network node 110 will now be described with reference to the flowchart depicted in FIG. 6. The method may be understood to be for handling the wake-up receiver. The network node 110 operates in a wireless communications network, such as the wireless communications network 100. The method may be understood to be computer-implemented.

In some embodiments, the wireless communications network 100 may support New Radio (NR).

Several embodiments are comprised herein. The first method may comprise one or more of the following actions. In some embodiments, all the actions may be performed. It should be noted that the examples herein may be not mutually exclusive. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the network node 110 is depicted in FIG. 6. In FIG. 6, optional actions in some embodiments may be represented with dashed lines. In some embodiments, the actions may be performed in a different order than that depicted FIG. 6.

The detailed description of some of the following corresponds to the same references provided above, in relation to the actions described for the wireless device 130 and will thus not be repeated here to simplify the description. For example, the connected mode may be an RRC Connected mode.

### Action 601

In this Action 601, the network node 110 may receive the first indication. The receiving in this Action 601 may be from the wireless device 130.

The receiving in this Action 601 may be performed, e.g., via the first link 141.

The first indication may indicate the capability of operation of the wake-up receiver.

### Action 602

In this Action 602, the network node 110 sends the second indication.

The sending in this Action 602 is to the wireless device 130 operating in the wireless communications network 100.

The sending in this Action 603 may be performed, e.g., via the first link 141.

The second indication indicates the configuration of usage or operation of the wake-up receiver in connected mode.

The wake-up receiver may be understood to be of the wireless device 130. That is, the wake-up receiver is comprised in the wireless device 130.

Whether or not to activate the wake-up receiver is based on an expiration of the first timer.

In some embodiments, at least one of the following options may apply. According to a first option, the configuration may configure the wireless device 130 to determine, while the wireless device 130 may be in connected mode, whether or not to activate the wake-up receiver, based on an expiration of the first timer. According to a second option, the first timer may be separately configured from the second timer; the second timer may be the connected mode discontinued reception (cDRX) timer. According to a third option, the wireless device 130 may be configured to determine to activate the wake-up receiver after expiration of the first timer. According to a fourth option, the wireless device 130 may be configured to determine to activate the wake-up receiver after expiration of the first timer and after monitoring downlink transmission with cDRX during the first period of time. And according to a fifth option, cDRX operation may be one of long and short.

In some embodiments, at least one of the following options may apply. According to a first option, the first timer may be used instead of the second timer. According to a second option, the wireless device 130 may be configured to determine to activate the wake-up receiver after expiration of the first timer and to refrain from monitoring downlink transmission with cDRX during the second period of time. According to a third option, the expiration of the first timer may trigger the always-on or continuous operation of the wake-up receiver. According to a fourth option, cDRX operation may be one of long and short. According to a fifth option, the wireless device 130 may be configured to determine to activate the wake-up receiver after expiration of the first timer and to refrain from monitoring downlink transmission with cDRX during the second period of time. In such examples, the cDRX may be long. According to a sixth option, the wireless device 130 may be configured to determine to activate the wake-up receiver after expiration of the first timer and to refrain from monitoring downlink transmission with cDRX during the second period of time. In such examples, the cDRX may be short.

### Action 603

In this Action 603, network node 110 may receive the third indication. The receiving in this Action 603 may be from the wireless device 130.

The receiving in this Action 603 may be performed, e.g., via the first link 141.

The third indication may indicate the wish to be kept in connected mode with the wake-up receiver. The wish may be understood to be of the wireless device 130.

### Action 604

In this Action 604, the network node 110 may the fourth indication. The sending in this Action 604 may be to the wireless device 130.

The sending in this Action 604 may be performed, e.g., via the first link 141.

The fourth indication may indicate the instruction to remain in connected mode with the wake-up receiver.

### Action 605

In this Action 605, the network node 110 may send the downlink transmission

The sending in this Action 605 may be to the wireless device 130.

The sending in this Action 605 may be performed, e.g., via the first link 141.

The downlink transmission may be to be detected by the wake-up receiver. The downlink transmission may be a downlink wake-up signal.

In some embodiments, the second indication may indicate at least one of the following options. According to a first option, the second indication may indicate the on/off configuration. According to a second option, the second indication may indicate the one or more properties of the first timer. According to a third option, the second indication may indicate the length of the duty cycle of the wake-up receiver. According to a fourth option, the second indication may indicate the first parameter indicating the second timer is reused for the wake-up receiver. According to a fifth option, the second indication may indicate the further indication indicating whether always-on wake-up receiver or duty-cycled wake-up receiver is to be used. According to a sixth option, the second indication may indicate the third timer to switch from always-on wake-up receiver and duty-cycled wake-up receiver. According to a seventh option, the second indication may indicate the power state to be used by the main receiver of the wireless device 130. According to an eighth option, the second indication may indicate the fourth timer to switch from duty-cycled wake-up receiver operations. According to a ninth option, the second indication may indicate the time gap between the wake-up signal occasion and the start of the search space of the physical downlink control channel. According to a tenth option, the second indication may indicate the wake-up receiver resources to be monitored by the wireless device 130. According to an eleventh option, the second indication may indicate the configuration of control signalling for enabling and/or disabling operation of wake-up signal.

The monitoring of the downlink transmission may be with the activated wake-up receiver.

In some embodiments, at least one of the following options may apply. According to a first option, the second indication may be comprised in the extension of the DRX configuration information element. According to a second option, the second indication may be comprised in the extension of the Physical Cell Group configuration information element. According to a third option, the third indication may be comprised in the UE assistance information message. According to a fourth option, the preference by the wireless device 130 for the configuration of the wake-up receiver may be indicated in UE assistance information.

In some embodiments, the second indication may indicate the second parameter indicating operation with the wake-up receiver replaces monitoring with long or short DRX.

In some embodiments, at least one of the following may apply: i) the connected mode may be the RRC Connected mode, ii) the separately configured timer may be the WUR-inactivity timer, iii) the activation of the wake-up receiver may be to monitor the downlink wake-up signal, iv) the main radio receiver of the wireless device 130 may be configured to be in a sleep mode during wake-up receiver operation v) the main radio receiver of the wireless device 130 may be configured to operate with the plurality of sleep modes during operation of the wake-up receiver, vi) the plurality of sleep modes may comprise at least one of: the ultra-low sleep mode, the light sleep mode, the deep sleep mode and the micro-sleep mode, vii) the sleep mode may be configured to be chosen for operation based on the type of wake-up radio operation, viii) the type of wake-up radio operation may be one of: always-on and duty-cycled wake-up radio operation, and ix) the first start and restart conditions of the first timer may be the same as second start and restart conditions of the second timer.

FIG. 7 is a schematic diagram illustrating a dedicated wake-up radio, that is, the first receiver, or WUR 701 accompanying the main receiver 702. As background, a dedicated wake up radio (WUR) 701 may be used for monitoring a wake-up signal (WUS) 703. Once a WUR 701 may detect the intended WUS 703, it may wake up the main baseband/Radio Frequency (RF)/less power efficient, receiver, that is the main receiver 702, to detect further incoming messages, depicted in FIG. 7 as “Main signal” 704. Therefore, the main receiver 702 may go to sleep mode and save power until it may be triggered by WUR 701. In order to exploit the benefits of WUR 701/WUS 703 in various use cases, it may be understood to be important to efficiently support WUR 701/WUS 703 in different RRC states including RRC_CONNECTED.

WUR operation in Connected may, for a UE indicating it is capable of WUR operation, as the wireless device 130 may have done in Action 501, for example, be triggered at the expiration of the first timer, in this example, a separately configured WUR inactivity timer referred to as WUR-inactivity Timer, or used instead of the long C-DRX, see the configuration section described in relation to Action 502 for a more complete list of alternatives. The procedure is outlined in FIG. 8. FIG. 8 is a schematic schematic diagram illustrating duty-cycled WUR operation in Connected. In the FIG. 8, a basic example is shown where the wireless device 130 first, as in legacy operation, after a time of inactivity indicated as “Idle/Inactive” in the figure during which the main receiver may be in deep sleep, may start monitoring the DL with Connected state DRX. During a first period of active time, the wireless device 130 may receive several signals, as well as exchange Radio Access Channel (RACH) communications and receive data, as well as PDCCH. After expiration of the second timer, a drx-Inactivity Timer, a cDRX period may begin, wherein short periods of PDCCH signalling may occur among intervals wherein the main receiver may be in deep sleep. But then, after the expiration of the first timer, that is a WUR-specific timer, which may be referred to herein as WUR-inactivityTimer, the wireless device 130 may start monitoring the DL with WUR operation. During this period, WUS occasions may occur between periods wherein the main receiver may be in ultra-low sleep. After expiration of yet another timer, a release timer, the wireless device 130 may fall back to idle/inactive state, during which period of signalling may occur between periods wherein main receiver may be in deep sleep.

In another case, the wireless device 130 may be configured to monitor WUS with the WUR continuously, that is, always-on WUR. This may be achieved by configuring the wireless device 130 with always-on operation which may be triggered either at the expiration of the new WUR inactivity timer WUR-inactivityTimer, or alternatively the wireless device 130 may be configured such that WUR operation may replace current C-DRX operation. That is, the legacy trigger drx-Inactivity Timer may be reused. This is illustrated in FIG. 9. FIG. 9 is a schematic schematic diagram illustrating always-on WUR operation in Connected. The description of the illustration depicted in FIG. 9 is similar to that shown in FIG. 8, except that the legacy trigger drx-InactivityTimer may be reused, and the WUS occasions begin at the expiration of the second timer, and end when the release timer may expire.

Certain embodiments disclosed herein may provide one or more of the following technical advantage(s), which may be summarized as follows.

Embodiments herein, may be understood to enable to make WUR operation applicable also to RRC_CONNECTED state, to achieve UE energy savings also when the wireless device 130 may reside in this state. The embodiments and examples described may enable an efficient WUR operation in the RRC_CONNECTED state to achieve power saving gain while ensuring latency constraints.

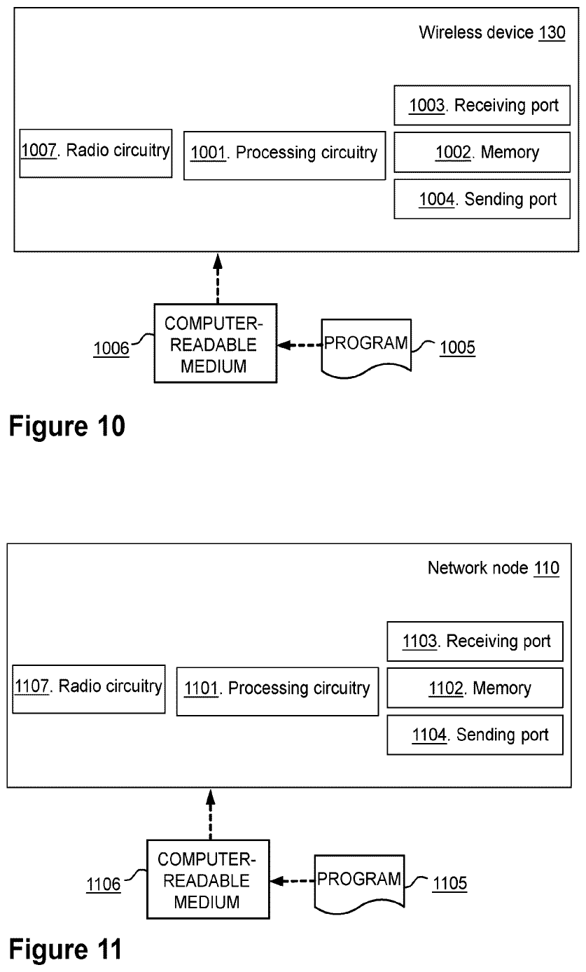

FIG. 10 depicts an example of the arrangement that the wireless device 130 may comprise to perform the method actions described above in relation to FIG. 5. The wireless device 130 may be understood to be for handling the wake-up receiver. The wireless device 130 may be configured to operate in the wireless communications network 100.

In some embodiments, the wireless communications network 100 may be configured to support NR.

Several embodiments are comprised herein. It should be noted that the examples herein are not mutually exclusive One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. In FIG. 10, optional units are indicated with dashed boxes. The detailed description of some of the following corresponds to the same references provided above, in relation to the actions described for the wireless device 130 and will thus not be repeated here. For example, the connected mode may be an RRC connected mode.

The wireless device 130 is configured to perform the determining of Action 505, e.g. by means of a processing circuitry 1001 within the wireless device 130 configured to, determine, while the wireless device 130 is in connected mode, whether or not to activate the wake-up receiver. The determining is configured to be based on the expiration of the first timer.

The wireless device 130 is configured to perform the initiating of Action 506, e.g. by means of the processing circuitry 1001 within the wireless device 130 configured to, initiate activation, while the wireless device 130 is in connected mode, of the wake-up receiver based on the result of the determination.

The wireless device 130 is configured to perform the monitoring of Action 507, e.g. by means of the processing circuitry 1001 within the wireless device 130 configured to, monitor the downlink transmission with the wake-up receiver configured to be activated.

In some embodiments, at least one of may apply: a) the first timer may be configured to be separately configured from the second timer; the second timer may be configured to be the connected mode discontinued reception, cDRX, timer, b) the wireless device 130 may be configured to determine to activate the wake-up receiver after expiration of the first timer, c) the wireless device 130 may be configured to determine to activate the wake-up receiver after expiration of the first timer and after monitoring downlink transmission with cDRX during the first period of time, and d) cDRX operation may be configured to be one of long and short.

In some embodiments, at least one of may apply: a) the first timer may be configured to be used instead of the second timer, b) the wireless device 130 may be configured to determine to activate the wake-up receiver after expiration of the first timer and may be configured to refrain from monitoring downlink transmission with cDRX during the second period of time, c) the expiration of the first timer may be configured to trigger the always-on or continuous operation of the wake-up receiver, d) cDRX operation may be configured to be one of long and short, e) the wireless device 130 may be configured to determine to activate the wake-up receiver after expiration of the first timer and may be configured to refrain from monitoring downlink transmission with cDRX during the second period of time in examples wherein the cDRX may be configured to long, and f) the wireless device 130 may be configured to determine to activate the wake-up receiver after expiration of the first timer and may be configured to refrain from monitoring downlink transmission with cDRX during the second period of time in examples wherein the cDRX may be configured to be short.

In some embodiments, the wireless device 130 may be further configured with at least one of the following four configurations.

In some embodiments, the wireless device 130 may be configured to perform the sending of Action 501, e.g. by means of the processing circuitry 1001 within the wireless device 130 configured to, send the first indication to the network node 110 configured to operate in the wireless communications network 100. The first indication may be configured to indicate the capability of operation of the wake-up receiver.

In some embodiments, the wireless device 130 may be configured to perform the receiving of Action 502, e.g. by means of the processing circuitry 1001 within the wireless device 130 configured to, receive the second indication from the network node 110. The second indication may be configured to indicate the configuration of usage or operation of the wake-up receiver in connected mode.

In some embodiments, the wireless device 130 may be configured to perform the sending of Action 503, e.g. by means of the processing circuitry 1001 within the wireless device 130 configured to, send the third indication to the network node 110. The third indication may be configured to indicate the wish to be kept in connected mode with the wake-up receiver.

In some embodiments, the wireless device 130 may be configured to perform the receiving of Action 504, e.g. by means of the processing circuitry 1001 within the wireless device 130 configured to, receive the fourth indication from the network node 110. The fourth indication may be configured to indicate the instruction to remain in connected mode with the wake-up receiver.

In some embodiments, the second indication may be configured to indicate at least one of the following: a) the on/off configuration, b) the one or more properties of the first timer, c) the length of the duty cycle of the wake-up receiver, d) the first parameter configured to indicate the second timer is reused for the wake-up receiver, e) the further indication configured to indicate whether always-on wake-up receiver or duty-cycled wake-up receiver is to be used, f) the third timer to switch from always-on wake-up receiver and duty-cycled wake-up receiver, g) the power state to be used by the main receiver of the wireless device 130, h) the fourth timer to switch from duty-cycled wake-up receiver operations, i) the time gap between the wake-up signal occasion and start of the search space of the physical downlink control channel, j) the wake-up receiver resources to be monitored by the wireless device 130, and k) the configuration of control signalling for enabling and/or disabling operation of wake-up signal.

In some embodiments, at least one of may apply: a) the second indication may be configured to be comprised in the extension of the DRX configuration information element, b) the second indication may be configured to be comprised in the extension of the Physical Cell Group configuration information element, c) the third indication may be configured to be comprised in the UE assistance information message, and d) the wireless device 130 may be configured to indicate the preference for the configuration of the wake-up receiver in UE assistance information.

In some embodiments, the second indication may be configured to indicate the second parameter indicating operation with the wake-up receiver replaces monitoring with long and/or short DRX.

In some embodiments, at least one of the following may apply: a) the connected mode may be configured to be the RRC Connected mode, b) the separately configured timer may be configured to be the WUR-inactivity timer, c) the activation of the wake-up receiver may be configured to be to monitor the downlink wake-up signal, d) the main radio receiver of the wireless device 130 may be configured to be in a sleep mode during wake-up receiver operation, e) the main radio receiver of the wireless device 130 may be configured to operate with the plurality of sleep modes during operation of the wake-up receiver, f) the plurality of sleep modes may be configured to comprise at least one of: the ultra-low sleep mode, the light sleep mode, the deep sleep mode and the micro-sleep mode, g) the sleep mode may be configured to be chosen for operation based on the type of wake-up radio operation, h) the type of wake-up radio operation may be configured to be one of: always-on and duty-cycled wake-up radio operation, and i) the first start and restart conditions of the first timer may be configured to be the same as second the start and restart conditions of the second timer.

The embodiments herein in the wireless device 130 may be implemented through one or more processors, such as a processing circuitry 1001 in the wireless device 130 depicted in FIG. 10, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the wireless device 130. One such carrier may be in the form of a CD ROM disc. It is however feasible with other data carriers such as a memory stick. The computer program code may furthermore be provided as pure program code on a server and downloaded to the wireless device 130.

The processing circuitry 1001 may be configured to, or operable to, perform the method actions according to FIG. 5.

The wireless device 130 may further comprise a memory 1002 comprising one or more memory units. The memory 1002 is arranged to be used to store obtained information, store data, configurations, schedulings, and applications etc. to perform the methods herein when being executed in the wireless device 130.

In some embodiments, the wireless device 130 may receive information from, e.g., the network node 110 or another structure in the wireless communications network 100, through a receiving port 1003. In some embodiments, the receiving port 1003 may be, for example, connected to one or more antennas in wireless device 130. In other embodiments, the wireless device 130 may receive information from another structure in the wireless communications network 100 through the receiving port 1003. Since the receiving port 1003 may be in communication with the processing circuitry 1001, the receiving port 1003 may then send the received information to the processing circuitry 1001. The receiving port 1003 may also be configured to receive other information.

The processing circuitry 1001 in the wireless device 130 may be further configured to transmit or send information to e.g., the network node 110 or another structure in the wireless communications network 100, through a sending port 1004, which may be in communication with the processing circuitry 1001, and the memory 1002.

Those skilled in the art will also appreciate that the processing circuitry 1001 described above may comprise a combination of analog and digital modules, and/or one or more processors configured with software and/or firmware, e.g., stored in memory, that, when executed by the one or more processors such as the processing circuitry 1001, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the wireless device 130 may be configured to perform the actions of FIG. 5 with respective units that may be implemented as one or more applications running on one or more processors such as the processing circuitry 1001.

Thus, the methods according to the embodiments described herein for the wireless device 130 may be respectively implemented by means of a computer program 1005 product, comprising instructions, i.e., software code portions, which, when executed on at least one processing circuitry 1001, cause the at least one processing circuitry 1001 to carry out the actions described herein, as performed by the wireless device 130. The computer program 1005 product may be stored on a computer-readable storage medium 1006. The computer-readable storage medium 1006, having stored thereon the computer program 1005, may comprise instructions which, when executed on at least one processing circuitry 1001, cause the at least one processing circuitry 1001 to carry out the actions described herein, as performed by the wireless device 130. In some embodiments, the computer-readable storage medium 1006 may be a non-transitory computer-readable storage medium, such as a CD ROM disc, or a memory stick. In other embodiments, the computer program 1005 product may be stored on a carrier containing the computer program 1005 just described, wherein the carrier is one of an electronic signal, optical signal, radio signal, or the computer-readable storage medium 1006, as described above.

The wireless device 130 may comprise a communication interface configured to facilitate communications between the wireless device 130 and other nodes or devices, e.g., the network node 110 or another structure in the wireless communications network 100. The interface may, for example, include a transceiver configured to transmit and receive radio signals over an air interface in accordance with a suitable standard.

In other embodiments, the wireless device 130 may also comprise a radio circuitry 1007, which may comprise e.g., the receiving port 1003 and the sending port 1004. The radio circuitry 1007 may be configured to set up and maintain at least a wireless connection with the network node 110 or another structure in the wireless communications network 100. Circuitry may be understood herein as a hardware component.

Hence, embodiments herein also relate to the wireless device 130 comprising the processing circuitry 1001 and the memory 1002, said memory 1002 containing instructions executable by said processing circuitry 1001, whereby the wireless device 130 is operative to perform the actions described herein in relation to the wireless device 130, e.g., in FIG. 5.

FIG. 11 depicts an example of the arrangement that the network node 110 may comprise to perform the method actions described above in relation to FIG. 6. The network node 110 may be understood to be for handling the wake-up receiver. The network node 110 may be configured to operate in the wireless communications network 100.

In some embodiments, the wireless communications network 100 may be configured to support NR.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the network node 110 and will thus not be repeated here. For example, the connected mode may be an RRC connected mode. In FIG. 11, optional units are indicated with dashed boxes.

The network node 110 is configured to perform the sending of Action 602, e.g. by means of the processing circuitry 1101 within the network node 110 configured to, send the second indication to the wireless device 130 configured to operate in the wireless communications network 100. The second indication is configured to indicate the configuration of usage or operation of the wake-up receiver in connected mode. The wake-up receiver may be understood to be configured to be comprised of the wireless device 130. That is, the wake-up receiver is configured to be comprised in the wireless device 130. Whether or not to activate the wake-up receiver is configured to be based on the expiration of the first timer.

In some embodiments, at least one of may apply: a) the configuration may be configured to configure the wireless device 130 to determine, while the wireless device 130 may be in connected mode, whether or not to activate the wake-up receiver, based on the expiration of the first timer, b) the first timer may be configured to be separately configured from the second timer; the second timer may be configured to be the connected mode discontinued reception, cDRX, timer, c) the wireless device 130 may be configured to determine to activate the wake-up receiver after expiration of the first timer, d) the wireless device 130 may be configured to determine to activate the wake-up receiver after expiration of the first timer and after monitoring downlink transmission with cDRX during the first period of time, and e) cDRX operation may be configured to be one of long and short.

In some embodiments, at least one of may apply: a) the first timer may be configured to be used instead of the second timer, b) the wireless device 130 may be configured to determine to activate the wake-up receiver after expiration of the first timer and may be configured to refrain from monitoring downlink transmission with cDRX during the second period of time, c) the expiration of the first timer may be configured to trigger the always-on or continuous operation of the wake-up receiver, d) cDRX operation may be configured to be one of long and short, e) the wireless device 130 may be configured to determine to activate the wake-up receiver after expiration of the first timer and may be configured to refrain from monitoring downlink transmission with cDRX during the second period of time in examples wherein the cDRX may be configured to long, and f) the wireless device 130 may be configured to determine to activate the wake-up receiver after expiration of the first timer and may be configured to refrain from monitoring downlink transmission with cDRX during the second period of time in examples wherein the cDRX may be configured to be short.

In some embodiments, the network node 110 may be further configured with at least one of the following four configurations.

The network node 110 may be configured to perform the receiving of Action 601, e.g. by means of the processing circuitry 1101 within the network node 110 configured to, receive the first indication from the wireless device 130. The first indication may be configured to indicate the capability of operation of the wake-up receiver.

The network node 110 may be configured to perform the receiving of Action 603, e.g. by means of the processing circuitry 1101 within the network node 110 configured to, receive the third indication from the wireless device 130. The third indication may be configured to indicate the wish to be kept in connected mode with the wake-up receiver.

The network node 110 may be configured to perform the sending of Action 604, e.g. by means of the processing circuitry 1101 within the network node 110 configured to, send the fourth indication to the wireless device 130. The fourth indication may be configured to indicate the instruction to remain in connected mode with the wake-up receiver.

The network node 110 may be configured to perform the sending of Action 605, e.g. by means of the processing circuitry 1101 within the network node 110 configured to, send the downlink transmission to the wireless device 130 to be detected by the wake-up receiver. The downlink transmission may be configured to be the downlink wake-up signal.

In some embodiments, the second indication may be configured to indicate at least one of the following: a) the on/off configuration, b) the one or more properties of the first timer, c) the length of the duty cycle of the wake-up receiver, d) the first parameter configured to indicate the second timer is reused for the wake-up receiver, e) the further indication configured to indicate whether always-on wake-up receiver or duty-cycled wake-up receiver is to be used, f) the third timer to switch from always-on wake-up receiver and duty-cycled wake-up receiver, g) the power state to be used by the main receiver of the wireless device 130, h) the fourth timer to switch from duty-cycled wake-up receiver operations, i) the time gap between the wake-up signal occasion and the start of the search space of the physical downlink control channel, j) the wake-up receiver resources to be monitored by the wireless device 130, and k) the configuration of control signalling for enabling and/or disabling operation of wake-up signal.

In some embodiments, at least one of may apply: a) the second indication may be configured to be comprised in the extension of the DRX configuration information element, b) the second indication may be configured to be comprised in the extension of the Physical Cell Group configuration information element, c) the third indication may be configured to be comprised in the UE assistance information message, and d) the preference by the wireless device 130 for the configuration of the wake-up receiver may be configured to be indicated in UE assistance information.

In some embodiments, the second indication may be configured to indicate the second parameter indicating operation with the wake-up receiver replaces monitoring with long and/or short DRX.

In some embodiments, at least one of the following may apply: a) the connected mode may be configured to be the RRC Connected mode, b) the separately configured timer may be configured to be the WUR-inactivity timer, c) the activation of the wake-up receiver may be configured to be to monitor the downlink wake-up signal, d) the main radio receiver of the wireless device 130 may be configured to be in the sleep mode during wake-up receiver operation, e) the main radio receiver of the wireless device 130 may be configured to operate with the plurality of sleep modes during operation of the wake-up receiver, f) the plurality of sleep modes may be configured to comprise at least one of: the ultra-low sleep mode, the light sleep mode, the deep sleep mode and the micro-sleep mode, g) the sleep mode may be configured to be chosen for operation based on the type of wake-up radio operation, h) the type of wake-up radio operation may be configured to be one of: always-on and duty-cycled wake-up radio operation, and i) the first start and restart conditions of the first timer may be configured to be the same as second the start and restart conditions of the second timer.

The embodiments herein in the network node 110 may be implemented through one or more processors, such as a processing circuitry 1101 in the network node 110 depicted in FIG. 11, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the network node 110. One such carrier may be in the form of a CD ROM disc. It is however feasible with other data carriers such as a memory stick. The computer program code may furthermore be provided as pure program code on a server and downloaded to the network node 110.

The processing circuitry 1101 may be configured to, or operable to, perform the method actions according to FIG. 6.

The network node 110 may further comprise a memory 1102 comprising one or more memory units. The memory 1102 is arranged to be used to store obtained information, store data, configurations, schedulings, and applications etc. to perform the methods herein when being executed in the network node 110.

In some embodiments, the network node 110 may receive information from, e.g., the wireless device 130 and/or another structure in the wireless communications network 100, through a receiving port 1103. In some embodiments, the receiving port 1103 may be, for example, connected to one or more antennas in network node 110. In other embodiments, the network node 110 may receive information from another structure in the wireless communications network 100 through the receiving port 1103. Since the receiving port 1103 may be in communication with the processing circuitry 1101, the receiving port 1103 may then send the received information to the processing circuitry 1101. The receiving port 1103 may also be configured to receive other information.

The processing circuitry 1101 in the network node 110 may be further configured to transmit or send information to e.g., the wireless device 130 and/or another structure in the wireless communications network 100, through a sending port 1104, which may be in communication with the processing circuitry 1101, and the memory 1102.

Those skilled in the art will also appreciate that the processing circuitry 1101 described above may comprise a combination of analog and digital modules, and/or one or more processors configured with software and/or firmware, e.g., stored in memory, that, when executed by the one or more processors such as the processing circuitry 1101, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the network node 110 may be configured to perform the actions of FIG. 6 with respective units that may be implemented as one or more applications running on one or more processors such as the processing circuitry 1101.

Thus, the methods according to the embodiments described herein for the network node 110 may be respectively implemented by means of a computer program 1105 product, comprising instructions, i.e., software code portions, which, when executed on at least one processing circuitry 1101, cause the at least one processing circuitry 1101 to carry out the actions described herein, as performed by the network node 110. The computer program 1105 product may be stored on a computer-readable storage medium 1106. The computer-readable storage medium 1106, having stored thereon the computer program 1105, may comprise instructions which, when executed on at least one processing circuitry 1101, cause the at least one processing circuitry 1101 to carry out the actions described herein, as performed by the network node 110. In some embodiments, the computer-readable storage medium 1106 may be a non-transitory computer-readable storage medium, such as a CD ROM disc, or a memory stick. In other embodiments, the computer program 1105 product may be stored on a carrier containing the computer program 1105 just described, wherein the carrier is one of an electronic signal, optical signal, radio signal, or the computer-readable storage medium 1106, as described above.

The network node 110 may comprise a communication interface configured to facilitate communications between the network node 110 and other nodes or devices, e.g., the wireless device 130 and/or another structure in the wireless communications network 100. The interface may, for example, include a transceiver configured to transmit and receive radio signals over an air interface in accordance with a suitable standard.

In other embodiments, the network node 110 may also comprise a radio circuitry 1107, which may comprise e.g., the receiving port 1103 and the sending port 1104. The radio circuitry 1107 may be configured to set up and maintain at least a wireless connection with the wireless device 130 and/or another structure in the wireless communications network 100. Circuitry may be understood herein as a hardware component.

Hence, embodiments herein also relate to the network node 110 comprising the processing circuitry 1101 and the memory 1102, said memory 1102 containing instructions executable by said processing circuitry 1101, whereby the network node 110 is operative to perform the actions described herein in relation to the network node 110, e.g., in FIG. 6.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

### EXAMPLES of, or Related to, Embodiments Herein

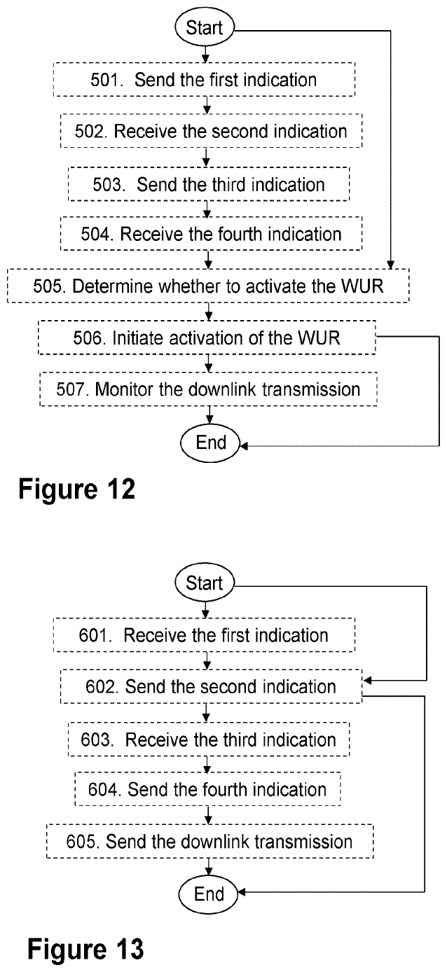

Examples related to embodiments herein may be as follows. It may be noted that any of the details already described in relation to FIGS. 5 and 6 may be also combined with the features described herein for FIGS. 12 and 13.

The wireless device 130 embodiments relate to FIG. 12, FIG. 5, FIGS. 7-10 and FIGS. 14-16.

A method, performed by a wireless device, such as the wireless device 130 is described herein. The method may be understood to be for handling a wake-up receiver. The wireless device 130 may be operating in a wireless communications network, such as the wireless communications network 100.

In some embodiments, the wireless communications network 100 may support New Radio (NR).

The method may comprise one or more of the following actions. In some embodiments, all the actions may be performed. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the wireless device 130 is depicted in FIG. 12. In FIG. 12 optional actions in some embodiments may be represented with dashed lines. In some embodiments, the actions may be performed in a different order than that depicted FIG. 12.
Determining 505 whether or not to activate a wake-up receiver. The wireless device 130 may be configured to perform the determining in this Action 505.

The wake-up may be understood to be of or comprised in the wireless device 130.

The determining in this Action 505 may be performed while the wireless device 130 is in connected mode, e.g., RRC Connected mode.

The determining in this Action 505 may be based on an expiration of a first timer.

In some embodiments, at least one of the following may apply:
the first timer may be separately configured from a second timer; the second timer may be a connected mode discontinued reception (cDRX) timer,
the wireless device 130 may determine to activate the wake-up receiver after expiration of the first timer,
the wireless device 130 may determine to activate the wake-up receiver after expiration of the first timer and after monitoring downlink transmission with cDRX during a first period of time, and
cDRX operation may be one of long and short.

In some embodiments, at least one of the following may apply:
the first timer may be used instead of the second timer,
the wireless device 130 may determine to activate the wake-up receiver after expiration of the first timer and may refrain from monitoring downlink transmission with cDRX during a second period of time,
the expiration of the first timer may trigger an always-on or continuous operation of the wake-up receiver,
cDRX operation may be one of long and short,
the wireless device 130 may determine to activate the wake-up receiver after expiration of the first timer and may refrain from monitoring downlink transmission with cDRX during a second period of time; In such examples, the cDRX may be long, and
the wireless device 130 may determine to activate the wake-up receiver after expiration of the first timer and may refrain from monitoring downlink transmission with cDRX during a second period of time; In such examples, the cDRX may be short.
Initiating 506 activation of the wake-up receiver. The wireless device 130 may be configured to perform the initiating in this Action 506.

The initiating activation of the wake-up receiver may be based on a result of the determination.

The initiating activation of the wake-up receiver in this Action 506 may be performed while the wireless device 130 is in connected mode.

In some embodiments, the method may further comprise one or more of the following actions:
Sending 501 a first indication. The wireless device 130 may be configured to perform the sending in this Action 501.

The sending in this Action 501 may be to the network node 110 operating in the wireless communications network 100.

The sending in this Action 501 may be, e.g., transmitting, and may be performed, e.g., via the first link 141.

The first indication may indicate a capability of operation of the wake-up receiver.
Receiving 502 a second indication. The wireless device 130 may be configured to perform the receiving in this Action 502.

The receiving in this Action 502 may be from the network node 110.

The receiving in this Action 501 may be performed, e.g., via the first link 141.

The second indication may indicate a configuration of usage or operation of the wake-up receiver in connected mode.

In some embodiments, the second indication may indicate at least one of:
an on/off configuration,
one or more properties of the first timer,
a length of a duty cycle of the wake-up receiver,
a first parameter indicating the second timer is reused for the wake-up receiver,
a further indication indicating whether always-on wake-up receiver or duty-cycled wake-up receiver is to be used,
a third timer to switch from always-on wake-up receiver and duty-cycled wake-up receiver,
a power state to be used by a main receiver of the wireless device 130,
a fourth timer to switch from duty-cycled wake-up receiver operations,
a time gap between a wake-up signal occasion and start of a search space of a physical downlink control channel,
wake-up receiver resources to be monitored by the wireless device 130, and
a configuration of control signalling for enabling and/or disabling operation of wake-up signal.
Sending 503 a third indication. The wireless device 130 may be configured to perform the sending in this Action 503.

The sending in this Action 503 may be to the network node 110.

The sending in this Action 503 may be, e.g., transmitting, and may be performed, e.g., via the first link 141.

The third indication may indicate a wish to be kept in connected mode with the wake-up receiver. The wish may be understood to be of the wireless device 130.
Receiving 504 a fourth indication. The wireless device 130 may be configured to perform the receiving in this Action 504.

The receiving in this Action 504 may be from the network node 110.

The receiving in this Action 504 may be performed, e.g., via the first link 141.

The fourth indication may indicate an instruction to remain in connected mode with the wake-up receiver.
Monitoring 507 a downlink transmission. The wireless device 130 may be configured to perform the monitoring in this Action 507.

The monitoring of the downlink transmission may be with the activated wake-up receiver.

In some embodiments, at least one of the following may apply:
the second indication may be comprised in an extension of a DRX configuration information element,
the second indication may be comprised in an extension of a Physical Cell Group configuration information element, and
the third indication may be comprised in a UE assistance information message.

In some embodiments, the second indication may indicate a second parameter indicating operation with the wake-up receiver replaces monitoring with long or short DRX.

In some embodiments, at least one of the following may apply:
i. the connected mode may be a Radio Resource Control (RRC) Connected mode,
ii. the separately configured timer may be a WUR-inactivity timer,
iii. the activation of the wake-up receiver may be to monitor a downlink wake-up signal,
iv. a main radio receiver of the wireless device 130 may be configured to operate with a plurality of sleep modes during operation of the wake-up receiver,
v. the plurality of sleep modes may comprise at least one of: an ultra-low sleep mode, a light sleep mode, a deep sleep mode and a micro-sleep mode,
vi. the sleep mode may be configured to be chosen for operation based on a type of wake-up radio operation,
vii. the type of wake-up radio operation may be one of: always-on and duty-cycled wake-up radio operation, and
viii. first start and restart conditions of the first timer may be the same as second start and restart conditions of the second timer.

In FIG. 12, optional units are indicated with dashed boxes.

The network node 110 embodiments relate to FIG. 13, FIG. 6, FIGS. 7-9, FIG. 11 and FIGS. 14-16.

A method, performed by a network node, such as the network node 110 is described herein. The method may be understood to be for handling the wake-up receiver0. The network node 110 may be operating in a wireless communications network, such as the wireless communications network 100.

In some embodiments, the wireless communications network 100 may support New Radio (NR).

The first method may comprise one or more of the following actions. In some embodiments, all the actions may be performed. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the network node 110 is depicted in FIG. 13. In FIG. 13, optional actions in some embodiments may be represented with dashed lines. In some embodiments, the actions may be performed in a different order than that depicted FIG. 13.

The detailed description of some of the following corresponds to the same references provided above, in relation to the actions described for the wireless device 130 and will thus not be repeated here to simplify the description. For example, the connected mode may be an RRC Connected mode.
Sending 602 the second indication. The network node 110 may be configured to perform the sending in this Action 602.

The sending in this Action 602 may be to the wireless device 130 operating in the wireless communications network 100.

The sending in this Action 603 may be performed, e.g., via the first link 141.

The second indication may indicate the configuration of usage or operation of the wake-up receiver in connected mode.

The wake-up receiver may be understood to be of/comprised in the wireless device 130.

Whether or not to activate the wake-up receiver may be based on an expiration of the first timer.

In some embodiments, at least one of the following may apply:
the configuration may configure the wireless device 130 to determine, while the wireless device 130 may be in connected mode, whether or not to activate the wake-up receiver, based on an expiration of the first timer,
the first timer may be separately configured from the second timer; the second timer may be the connected mode discontinued reception (cDRX) timer,
the wireless device 130 may be configured to determine to activate the wake-up receiver after expiration of the first timer,
the wireless device 130 may be configured to determine to activate the wake-up receiver after expiration of the first timer and after monitoring downlink transmission with cDRX during the first period of time, and
cDRX operation may be one of long and short.

In some embodiments, at least one of the following may apply:
the first timer may be used instead of the second timer,
the wireless device 130 may be configured to determine to activate the wake-up receiver after expiration of the first timer and to refrain from monitoring downlink transmission with cDRX during the second period of time,
the expiration of the first timer may trigger the always-on or continuous operation of the wake-up receiver,
cDRX operation may be one of long and short,
the wireless device 130 may be configured to determine to activate the wake-up receiver after expiration of the first timer and to refrain from monitoring downlink transmission with cDRX during the second period of time; In such examples, the cDRX may be long, and
the wireless device 130 may be configured to determine to activate the wake-up receiver after expiration of the first timer and to refrain from monitoring downlink transmission with cDRX during the second period of time; In such examples, the cDRX may be short.
Receiving 601 the first indication. The network node 110 may be configured to perform the receiving in this Action 601.

The receiving in this Action 601 may be from the wireless device 130.

The receiving in this Action 601 may be performed, e.g., via the first link 141.

The first indication may indicate the capability of operation of the wake-up receiver.
Receiving 603 the third indication. The network node 110 may be configured to perform the receiving in this Action 603.

The receiving in this Action 603 may be from the wireless device 130.

The receiving in this Action 603 may be performed, e.g., via the first link 141.

The third indication may indicate the wish to be kept in connected mode with the wake-up receiver. The wish may be understood to be of the wireless device 130.
Sending 604 the fourth indication. The network node 110 may be configured to perform the sending in this Action 604.

The sending in this Action 604 may be to the wireless device 130.

The sending in this Action 604 may be performed, e.g., via the first link 141.

The fourth indication may indicate the instruction to remain in connected mode with the wake-up receiver.
Sending 605 the downlink transmission. The network node 110 may be configured to perform the sending in this Action 605.

The sending in this Action 605 may be to the wireless device 130.

The sending in this Action 605 may be performed, e.g., via the first link 141.

The downlink transmission may be to be detected by the wake-up receiver. The downlink transmission may be a downlink wake-up signal.

In some embodiments, the second indication may indicate at least one of:
the on/off configuration,
the one or more properties of the first timer,
the length of the duty cycle of the wake-up receiver,
the first parameter indicating the second timer is reused for the wake-up receiver,
the further indication indicating whether always-on wake-up receiver or duty-cycled wake-up receiver is to be used,
the third timer to switch from always-on wake-up receiver and duty-cycled wake-up receiver,
the power state to be used by the main receiver of the wireless device 130,
the fourth timer to switch from duty-cycled wake-up receiver operations,
the time gap between the wake-up signal occasion and the start of the search space of the physical downlink control channel,
the wake-up receiver resources to be monitored by the wireless device 130, and
the configuration of control signalling for enabling and/or disabling operation of wake-up signal.

The monitoring of the downlink transmission may be with the activated wake-up receiver.

In some embodiments, at least one of the following may apply:
the second indication may be comprised in the extension of the DRX configuration information element,
the second indication may be comprised in the extension of the Physical Cell Group configuration information element, and
the third indication may be comprised in the UE assistance information message.

In some embodiments, the second indication may indicate the second parameter indicating operation with the wake-up receiver replaces monitoring with long or short DRX.

In some embodiments, at least one of the following may apply:
i. the connected mode may be the RRC Connected mode,
ii. the separately configured timer may be the WUR-inactivity timer,
iii. the activation of the wake-up receiver may be to monitor the downlink wake-up signal,
iv. the main radio receiver of the wireless device 130 may be configured to operate with the plurality of sleep modes during operation of the wake-up receiver,
v. the plurality of sleep modes may comprise at least one of: the ultra-low sleep mode, the light sleep mode, the deep sleep mode and the micro-sleep mode,
vi. the sleep mode may be configured to be chosen for operation based on the type of wake-up radio operation,
vii. the type of wake-up radio operation may be one of: always-on and duty-cycled wake-up radio operation, and
viii. the first start and restart conditions of the first timer may be the same as second start and restart conditions of the second timer.

In FIG. 13, optional units are indicated with dashed boxes.

Numbered examples related to embodiments herein:
Example 1. A method performed by a wireless device (130), the method being for handling a wake-up receiver, the wireless device (130) operating in a wireless communications network (100), the method comprising:
   determining (505), while the wireless device (130) is in connected mode, whether or not to activate a wake-up receiver, wherein the determining (502) is based on an expiration of a first timer, and
   initiating (506) activation, while the wireless device (130) is in connected mode, of the wake-up receiver based on a result of the determination.
Example 2. The method according to example 1, wherein at least one of:
   the first timer is separately configured from a second timer, wherein the second timer is a connected mode discontinued reception, cDRX, timer,
   the wireless device (130) determines to activate the wake-up receiver after expiration of the first timer,
   the wireless device (130) determines to activate the wake-up receiver after expiration of the first timer and after monitoring downlink transmission with cDRX during a first period of time, and
   wherein cDRX operation is one of long and short.
Example 3. The method according to example 1, wherein at least one of:
   the first timer is used instead of the second timer,
   the wireless device (130) determines to activate the wake-up receiver after expiration of the first timer and refrains from monitoring downlink transmission with cDRX during a second period of time,
   the expiration of the first timer triggers an always-on or continuous operation of the wake-up receiver,
   wherein cDRX operation is one of long and short,
   the wireless device (130) determines to activate the wake-up receiver after expiration of the first timer and refrains from monitoring downlink transmission with cDRX during a second period of time, wherein the cDRX is long, and
   the wireless device (130) determines to activate the wake-up receiver after expiration of the first timer and refrains from monitoring downlink transmission with cDRX during a second period of time, wherein the cDRX is short.
Example 4. The method according to any of examples 1-2, further comprising at least one of:
   sending (501) a first indication to a network node (110) operating in the wireless communications network (100), the first indication indicating a capability of operation of the wake-up receiver,
   receiving (502) a second indication from the network node (110), the second indication indicating a configuration of usage or operation of the wake-up receiver in connected mode,
   sending (503) a third indication to the network node (110), the third indication indicating a wish to be kept in connected mode with the wake-up receiver,
   receiving (504) a fourth indication from the network node (110), the fourth indication indicating an instruction to remain in connected mode with the wake-up receiver, and
   monitoring (507) downlink transmission with the activated wake-up receiver.
Example 5. The method according to examples 2 or 3 and 4, wherein the second indication indicates at least one of:
   an on/off configuration,
   one or more properties of the first timer,
   a length of a duty cycle of the wake-up receiver,
   a first parameter indicating the second timer is reused for the wake-up receiver,
   a further indication indicating whether always-on wake-up receiver or duty-cycled wake-up receiver is to be used,
   a third timer to switch from always-on wake-up receiver and duty-cycled wake-up receiver,
   a power state to be used by a main receiver of the wireless device (130),
   a fourth time to switch from duty-cycled wake-up receiver operations,
   a time gap between a wake-up signal occasion and start of a search space of a physical downlink control channel,
   wake-up receiver resources to be monitored by the wireless device (130), and
   a configuration of control signalling for enabling and/or disabling operation of wake-up signal.
Example 6. The method according to any of examples 4-5, wherein least one of:
   the second indication is comprised in an extension of a DRX configuration information element,
   the second indication is comprised in an extension of a Physical Cell Group configuration information element, and
   the third indication is comprised in a UE assistance information message.
Example 7. The method according to examples 3 and 4, wherein the second indication indicates a second parameter indicating operation with the wake-up receiver replaces monitoring with long or short DRX.
Example 8. The method according to any of examples 1-7, wherein at least one of:
   i. the connected mode is a Radio Resource Control, RRC, Connected mode,
   ii. the separately configured timer is a WUR-inactivity timer,
   iii. the activation of the wake-up receiver is to monitor a downlink wake-up signal,
   iv. wherein a main radio receiver of the wireless device (130) is configured to operate with a plurality of sleep modes during operation of the wake-up receiver,
   v. wherein the plurality of sleep modes comprise at least one of: an ultra-low sleep mode, a light sleep mode, a deep sleep mode and a micro-sleep mode,
   vi. wherein the sleep mode is configured to be chosen for operation based on a type of wake-up radio operation,
   vii. wherein the type of wake-up radio operation is one of: always-on and duty-cycled wake-up radio operation, and
   viii. first start and restart conditions of the first timer are the same as second start and restart conditions of the second timer.
Example 9. A method performed by a network node (110), the method being for handling a wake-up receiver, the network node (110) operating in a wireless communications network (100), the method comprising:
   send (602) a second indication to a wireless device (130) operating in the wireless communications network (100), the second indication indicating a configuration of usage or operation of the wake-up receiver in connected mode, the wake-up receiver being of/comprised in the wireless device (130), wherein whether or not to activate the wake-up receiver is based on an expiration of a first timer.
Example 10. The method according to example 9, wherein at least one of:
   the configuration configures the wireless device (130) to determine, while the wireless device (130) is in connected mode, whether or not to activate the wake-up receiver, based on an expiration of the first timer,
   the first timer is separately configured from a second timer, wherein the second timer is a connected mode discontinued reception, cDRX, timer,
   the wireless device (130) is configured to determine to activate the wake-up receiver after expiration of the first timer,
   the wireless device (130) is configured to determine to activate the wake-up receiver after expiration of the first timer and after monitoring downlink transmission with cDRX during a first period of time, and
   wherein cDRX operation is one of long and short.
Example 11. The method according to example 9, wherein at least one of:
   the first timer is used instead of the second timer,
   the wireless device (130) is configured to determine to activate the wake-up receiver after expiration of the first timer and to refrain from monitoring downlink transmission with cDRX during a second period of time,
   the expiration of the first timer triggers an always-on or continuous operation of the wake-up receiver,
   wherein cDRX operation is one of long and short,
   the wireless device (130) is configured to determine to activate the wake-up receiver after expiration of the first timer and to refrain from monitoring downlink transmission with cDRX during a second period of time, wherein the cDRX is long, and
   the wireless device (130) is configured to determine to activate the wake-up receiver after expiration of the first timer and to refrain from monitoring downlink transmission with cDRX during a second period of time, wherein the cDRX is short.
Example 12. The method according to any of examples 9-11, further comprising at least one of:
   receiving (601) a first indication from the wireless device (130), the first indication indicating a capability of operation of the wake-up receiver,
   receiving (603) a third indication from the wireless device (130), the third indication indicating a wish to be kept in connected mode with the wake-up receiver,
   sending (604) a fourth indication to the wireless device (130), the fourth indication indicating an instruction to remain in connected mode with the wake-up receiver, and
   sending (605) a downlink transmission to the wireless device (130) to be detected by the wake-up receiver, wherein the downlink transmission is a downlink wake-up signal.
Example 13. The method according to any of examples 10-12, wherein the second indication indicates at least one of:
   an on/off configuration,
   one or more properties of the first timer,
   a length of a duty cycle of the wake-up receiver,
   a first parameter indicating the second timer is reused for the wake-up receiver,
   a further indication indicating whether always-on wake-up receiver or duty-cycled wake-up receiver is to be used,
   a third timer to switch from always-on wake-up receiver and duty-cycled wake-up receiver,
   a power state to be used by a main receiver of the wireless device (130),
   a fourth timer to switch from duty-cycled wake-up receiver operations,
   a time gap between a wake-up signal occasion and start of a search space of a physical downlink control channel,
   wake-up receiver resources to be monitored by the wireless device (130), and
   a configuration of control signalling for enabling and/or disabling operation of wake-up signal.
Example 14. The method according to any of examples 12-13, wherein least one of:
   the second indication is comprised in an extension of a DRX configuration information element,
   the second indication is comprised in an extension of a Physical Cell Group configuration information element, and
   the third indication is comprised in a UE assistance information message,
Example 15. The method according to examples 3 and 4, wherein the second indication indicates at least one of:
   a second parameter indicating operation with the wake-up receiver replaces monitoring with long or short DRX.
Example 16. The method according to any of examples 10-15, wherein at least one of:
   i. the connected mode is a Radio Resource Control, RRC, Connected mode,
   ii. the separately configured timer is a WUR-inactivity timer,
   iii. the activation of the wake-up receiver is to monitor a downlink wake-up signal,
   iv. wherein a main radio receiver of the wireless device (130) is configured to operate with a plurality of sleep modes during operation of the wake-up receiver,
   v. wherein the plurality of sleep modes comprise at least one of: an ultra-low sleep mode, a light sleep mode, a deep sleep mode and a micro-sleep mode,
   vi. wherein the sleep mode is configured to be chosen for operation based on a type of wake-up radio operation,
   vii. wherein the type of wake-up radio operation is one of: always-on and duty-cycled wake-up radio operation, and
   viii. first start and restart conditions of the first timer are the same as second start and restart conditions of the second timer.

### Further Extensions And Variations

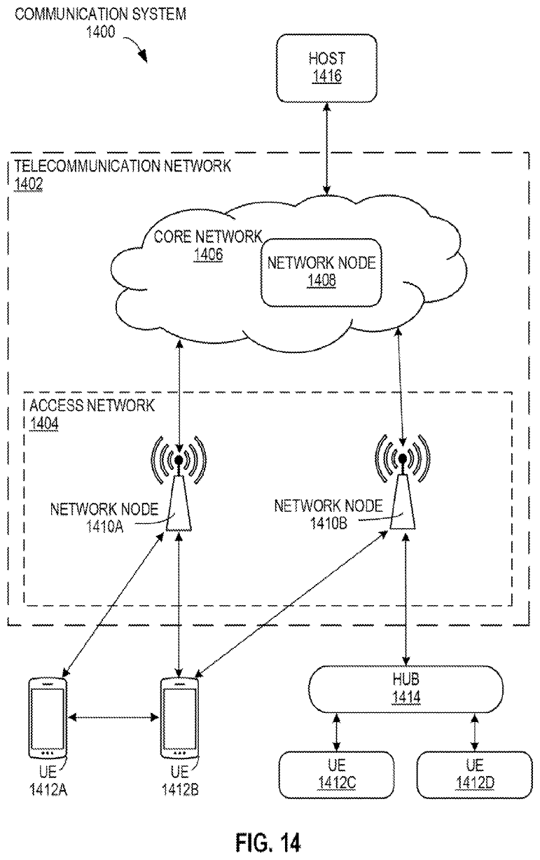

FIG. 14 shows an example of a communication system 1400 in accordance with some embodiments.

In the example, the communication system 1400, such as the wireless communications network 100, includes a telecommunication network 1402 that includes an access network 1404, such as a radio access network (RAN), and a core network 1406, which includes one or more core network nodes 1408. The access network 1404 includes one or more access network nodes, such as the network node 110. For example, network nodes 1410a and 1410b, one or more of which may be generally referred to as network nodes 1410, or any other similar 3^{rd} Generation Partnership Project (3GPP) access node or non-3GPP access point. The communications system 1400 comprises a plurality of wireless devices, such as the wireless device 130. In FIG. 14, the plurality of wireless devices comprises UEs 1412a, 1412b, 1412c, and 1412d, one or more of which may be generally referred to as UEs 1412. The network nodes 1410 facilitate direct or indirect connection of user equipment (UE), such as by connecting UEs 1412a, 1412b, 1412c, and 1412d to the core network 1406 over one or more wireless connections. Any of the UEs 1412a, 1412b, 1412c, and 1412d are examples of the wireless device 130.

In relation to FIGS. 14, 15, and 16, which are described next, it may be understood that any UE is an example of the wireless device 130, and that any description provided for the UE 1412 or for the UE 1606 equally applies to the wireless device 130. It may be also understood that any network node is an example of the network node 110, and that any description provided for any network node 1410 or for the network node 1604 equally applies to the network node 110. It may further be understood that the communication system 1400 is an example of the wireless communication network 100, and that any description provided for the communication system 1400 equally applies to the wireless communication network 100.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1400 may include any number of wired or wireless networks, network nodes, UEs, and/or any other components or systems that may facilitate or participate in the communication of data and/or signals whether via wired or wireless connections. The communication system 1400 may include and/or interface with any type of communication, telecommunication, data, cellular, radio network, and/or other similar type of system.

The wireless device 130, exemplified in FIG. 14 as the UEs 1412, may be any of a wide variety of communication devices, including wireless devices arranged, configured, and/or operable to communicate wirelessly with the network node 110, exemplified in FIG. 14 as network nodes 1410, and other communication devices. Similarly, the network nodes 1410 are arranged, capable, configured, and/or operable to communicate directly or indirectly with the UEs 1412 and/or with other network nodes or equipment in the telecommunication network 1402 to enable and/or provide network access, such as wireless network access, and/or to perform other functions, such as administration in the telecommunication network 1402.

In the depicted example, the core network 1406 connects the network nodes 1410 to one or more hosts, such as host 1416. These connections may be direct or indirect via one or more intermediary networks or devices. In other examples, network nodes may be directly coupled to hosts. The core network 1406 includes one more core network nodes, e.g., core network node 1408, that are structured with hardware and software components. Features of these components may be substantially similar to those described with respect to the UEs, network nodes, and/or hosts, such that the descriptions thereof are generally applicable to the corresponding components of the core network node 1408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a UPF.

The host 1416 may be under the ownership or control of a service provider other than an operator or provider of the access network 1404 and/or the telecommunication network 1402, and may be operated by the service provider or on behalf of the service provider. The host 1416 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1400 of FIG. 14 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1402 is a cellular network that implements 3GPP standardized features. Accordingly, the telecommunications network 1402 may support network slicing to provide different logical networks to different devices that are connected to the telecommunication network 1402. For example, the telecommunications network 1402 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1412 are configured to transmit and/or receive information without direct human interaction. For instance, a UE may be designed to transmit information to the access network 1404 on a predetermined schedule, when triggered by an internal or external event, or in response to requests from the access network 1404. Additionally, a UE may be configured for operating in single- or multi-RAT or multi-standard mode. For example, a UE may operate with any one or combination of Wi-Fi, New Radio (NR) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 1414 communicates with the access network 1404 to facilitate indirect communication between one or more UEs, e.g., UE 1412c and/or 1412d, and network nodes, e.g., network node 1410b. In some examples, the hub 1414 may be a controller, router, content source and analytics, or any of the other communication devices described herein regarding UEs. For example, the hub 1414 may be a broadband router enabling access to the core network 1406 for the UEs. As another example, the hub 1414 may be a controller that sends commands or instructions to one or more actuators in the UEs. Commands or instructions may be received from the UEs, network nodes 1410, or by executable code, script, process, or other instructions in the hub 1414. As another example, the hub 1414 may be a data collector that acts as temporary storage for UE data and, in some embodiments, may perform analysis or other processing of the data. As another example, the hub 1414 may be a content source. For example, for a UE that is a VR headset, display, loudspeaker or other media delivery device, the hub 1414 may retrieve VR assets, video, audio, or other media or data related to sensory information via a network node, which the hub 1414 then provides to the UE either directly, after performing local processing, and/or after adding additional local content. In still another example, the hub 1414 acts as a proxy server or orchestrator for the UEs, in particular in if one or more of the UEs are low energy IoT devices.

The hub 1414 may have a constant/persistent or intermittent connection to the network node 1410b. The hub 1414 may also allow for a different communication scheme and/or schedule between the hub 1414 and UEs (e.g., UE 1412c and/or 1412d), and between the hub 1414 and the core network 1406. In other examples, the hub 1414 is connected to the core network 1406 and/or one or more UEs via a wired connection. Moreover, the hub 1414 may be configured to connect to an M2M service provider over the access network 1404 and/or to another UE over a direct connection. In some scenarios, UEs may establish a wireless connection with the network nodes 1410 while still connected via the hub 1414 via a wired or wireless connection. In some embodiments, the hub 1414 may be a dedicated hub—that is, a hub whose primary function is to route communications to/from the UEs from/to the network node 1410b. In other embodiments, the hub 1414 may be a non-dedicated hub—that is, a device which is capable of operating to route communications between the UEs and network node 1410b, but which is additionally capable of operating as a communication start and/or end point for certain data channels.

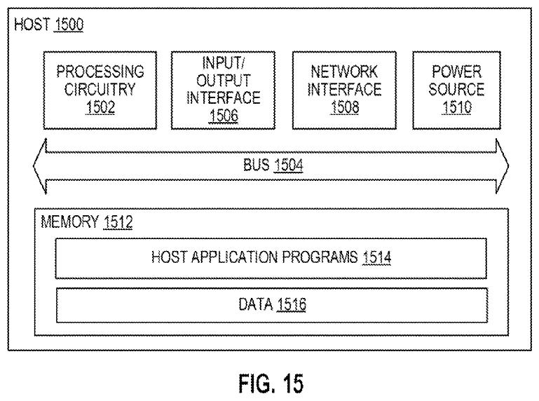

FIG. 15 is a block diagram of a host 1500, which may be an embodiment of the host 1416 of FIG. 14, in accordance with various aspects described herein. As used herein, the host 1500 may be or comprise various combinations hardware and/or software, including a standalone server, a blade server, a cloud-implemented server, a distributed server, a virtual machine, container, or processing resources in a server farm. The host 1500 may provide one or more services to one or more UEs.

The host 1500 includes processing circuitry 1502 that is operatively coupled via a bus 1504 to an input/output interface 1506, a network interface 1508, a power source 1510, and a memory 1512. Other components may be included in other embodiments. Features of these components may be substantially similar to those described with respect to the devices of previous figures, such that the descriptions thereof are generally applicable to the corresponding components of host 1500.

The memory 1512 may include one or more computer programs including one or more host application programs 1514 and data 1516, which may include user data, e.g., data generated by a UE for the host 1500 or data generated by the host 1500 for a UE. Embodiments of the host 1500 may utilize only a subset or all of the components shown. The host application programs 1514 may be implemented in a container-based architecture and may provide support for video codecs, (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1514 may also provide for user authentication and licensing checks and may periodically report health, routes, and content availability to a central node, such as a device in or on the edge of a core network. Accordingly, the host 1500 may select and/or indicate a different host for over-the-top services for a UE. The host application programs 1514 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

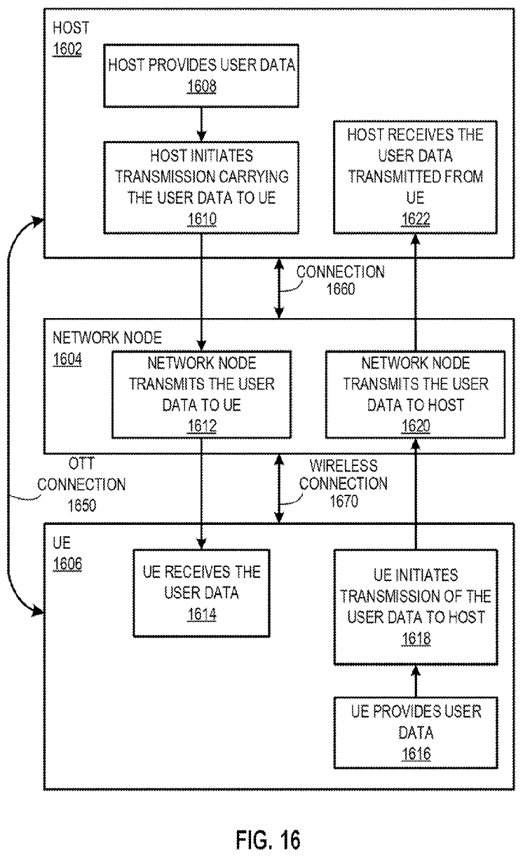

FIG. 16 shows a communication diagram of a host 1602 communicating via a network node 1604 with a UE 1606 over a partially wireless connection in accordance with some embodiments. Example implementations, in accordance with various embodiments, of the UE, such as a UE 1412a of Figure QQ, network node, such as network node 1410a of FIG. 14, and host, such as host 1416 of FIG. 14 and/or host 1500 of FIG. 15, discussed in the preceding paragraphs will now be described with reference to FIG. 16.

Like host 1500, embodiments of host 1602 include hardware, such as a communication interface, processing circuitry, and memory. The host 1602 also includes software, which is stored in or accessible by the host 1602 and executable by the processing circuitry. The software includes a host application that may be operable to provide a service to a remote user, such as the UE 1606 connecting via an over-the-top (OTT) connection 1650 extending between the UE 1606 and host 1602. In providing the service to the remote user, a host application may provide user data which is transmitted using the OTT connection 1650.

The network node 1604 includes hardware enabling it to communicate with the host 1602 and UE 1606. The connection 1660 may be direct or pass through a core network (like core network 1406 of FIG. 14) and/or one or more other intermediate networks, such as one or more public, private, or hosted networks. For example, an intermediate network may be a backbone network or the Internet.

The UE 1606 includes hardware and software, which is stored in or accessible by UE 1606 and executable by the UE's processing circuitry. The software includes a client application, such as a web browser or operator-specific “app” that may be operable to provide a service to a human or non-human user via UE 1606 with the support of the host 1602. In the host 1602, an executing host application may communicate with the executing client application via the OTT connection 1650 terminating at the UE 1606 and host 1602. In providing the service to the user, the UE's client application may receive request data from the host's host application and provide user data in response to the request data. The OTT connection 1650 may transfer both the request data and the user data. The UE's client application may interact with the user to generate the user data that it provides to the host application through the OTT connection 1650.

The OTT connection 1650 may extend via a connection 1660 between the host 1602 and the network node 1604 and via a wireless connection 1670 between the network node 1604 and the UE 1606 to provide the connection between the host 1602 and the UE 1606. The connection 1660 and wireless connection 1670, over which the OTT connection 1650 may be provided, have been drawn abstractly to illustrate the communication between the host 1602 and the UE 1606 via the network node 1604, without explicit reference to any intermediary devices and the precise routing of messages via these devices.

As an example of transmitting data via the OTT connection 1650, in step 1608, the host 1602 provides user data, which may be performed by executing a host application. In some embodiments, the user data is associated with a particular human user interacting with the UE 1606. In other embodiments, the user data is associated with a UE 1606 that shares data with the host 1602 without explicit human interaction. In step 1610, the host 1602 initiates a transmission carrying the user data towards the UE 1606. The host 1602 may initiate the transmission responsive to a request transmitted by the UE 1606. The request may be caused by human interaction with the UE 1606 or by operation of the client application executing on the UE 1606. The transmission may pass via the network node 1604, in accordance with the teachings of the embodiments described throughout this disclosure. Accordingly, in step 1612, the network node 1604 transmits to the UE 1606 the user data that was carried in the transmission that the host 1602 initiated, in accordance with the teachings of the embodiments described throughout this disclosure. In step 1614, the UE 1606 receives the user data carried in the transmission, which may be performed by a client application executed on the UE 1606 associated with the host application executed by the host 1602.

In some examples, the UE 1606 executes a client application which provides user data to the host 1602. The user data may be provided in reaction or response to the data received from the host 1602. Accordingly, in step 1616, the UE 1606 may provide user data, which may be performed by executing the client application. In providing the user data, the client application may further consider user input received from the user via an input/output interface of the UE 1606. Regardless of the specific manner in which the user data was provided, the UE 1606 initiates, in step 1618, transmission of the user data towards the host 1602 via the network node 1604. In step 1620, in accordance with the teachings of the embodiments described throughout this disclosure, the network node 1604 receives user data from the UE 1606 and initiates transmission of the received user data towards the host 1602. In step 1622, the host 1602 receives the user data carried in the transmission initiated by the UE 1606.

One or more of the various embodiments improve the performance of OTT services provided to the UE 1606 using the OTT connection 1650, in which the wireless connection 1670 forms the last segment. More precisely, the teachings of these embodiments may improve the data rate, latency, power consumption and thereby provide benefits such as reduced user waiting time, relaxed restriction on file size, improved content resolution, better responsiveness, and extended battery lifetime.

In an example scenario, factory status information may be collected and analyzed by the host 1602. As another example, the host 1602 may process audio and video data which may have been retrieved from a UE for use in creating maps. As another example, the host 1602 may collect and analyze real-time data to assist in controlling vehicle congestion, e.g., controlling traffic lights. As another example, the host 1602 may store surveillance video uploaded by a UE. As another example, the host 1602 may store or control access to media content such as video, audio, VR or AR which it can broadcast, multicast or unicast to UEs. As other examples, the host 1602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1650 between the host 1602 and UE 1606, in response to variations in the measurement results. The measurement procedure and/or the network functionality for reconfiguring the OTT connection may be implemented in software and hardware of the host 1602 and/or UE 1606. In some embodiments, sensors, not shown, may be deployed in or in association with other devices through which the OTT connection 1650 passes; the sensors may participate in the measurement procedure by supplying values of the monitored quantities exemplified above, or supplying values of other physical quantities from which software may compute or estimate the monitored quantities. The reconfiguring of the OTT connection 1650 may include message format, retransmission settings, preferred routing etc.; the reconfiguring need not directly alter the operation of the network node 1604. Such procedures and functionalities may be known and practiced in the art. In certain embodiments, measurements may involve proprietary UE signaling that facilitates measurements of throughput, propagation times, latency and the like, by the host 1602. The measurements may be implemented in that software causes messages to be transmitted, in particular empty or ‘dummy’ messages, using the OTT connection 1650 while monitoring propagation times, errors, etc.

The wireless device 130 may comprise an arrangement as shown in FIG. 5 or in FIG. 16.

The network node 110 may comprise an arrangement as shown in FIG. 6 or in FIG. 16.

### Further Numbered Embodiments

1. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform one or more of the actions described herein as performed by the network node 110.

2. The host of the previous embodiment, wherein:
the processing circuitry of the host is configured to execute a host application that provides the user data; and
the UE comprises processing circuitry configured to execute a client application associated with the host application to receive the transmission of user data from the host.

3. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs one or more of the actions described herein as performed by the network node 110.

4. The method of the previous embodiment, further comprising, at the network node, transmitting the user data provided by the host for the UE.

5. The method of any of the previous 2 embodiments, wherein the user data is provided at the host by executing a host application that interacts with a client application executing on the UE, the client application being associated with the host application.

6. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform one or more of the actions described herein as performed by the network node 110.

7. The communication system of the previous embodiment, further comprising:
the network node; and/or
the user equipment.

8. The communication system of the previous 2 embodiments, wherein:
the processing circuitry of the host is configured to execute a host application, thereby providing the user data; and
the host application is configured to interact with a client application executing on the UE, the client application being associated with the host application.

9. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform one or more of the actions described herein as performed by the network node 110.

10. The host of the previous 2 embodiments, wherein:
the processing circuitry of the host is configured to execute a host application, thereby providing the user data; and
the host application is configured to interact with a client application executing on the UE, the client application being associated with the host application.

11. The host of the any of the previous 2 embodiments, wherein the initiating receipt of the user data comprises requesting the user data.

12. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs one or more of the actions described herein as performed by the network node 110.

13. The method of the previous embodiment, further comprising at the network node, transmitting the received user data to the host.

14. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform one or more of the actions described herein as performed by the wireless device 130.

15. The host of the previous embodiment, wherein the cellular network further includes a network node configured to communicate with the UE to transmit the user data to the UE from the host.

16. The host of the previous 2 embodiments, wherein:
the processing circuitry of the host is configured to execute a host application, thereby providing the user data; and
the host application is configured to interact with a client application executing on the UE, the client application being associated with the host application.

17. A method implemented by a host operating in a communication system that further includes a network node and a user equipment (UE), the method comprising:
providing user data for the UE; and
initiating a transmission carrying the user data to the UE via a cellular network comprising the network node, wherein the UE performs one or more of the actions described herein as performed by the wireless device 130.

18. The method of the previous embodiment, further comprising:
at the host, executing a host application associated with a client application executing on the UE to receive the user data from the UE.

19. The method of the previous embodiment, further comprising:
at the host, transmitting input data to the client application executing on the UE, the input data being provided by executing the host application,
wherein the user data is provided by the client application in response to the input data from the host application.

20. A host configured to operate in a communication system to provide an over-the-top (OTT) service, the host comprising:
processing circuitry configured to utilize user data; and
a network interface configured to receipt of transmission of the user data to a cellular network for transmission to a user equipment (UE),
wherein the UE comprises a communication interface and processing circuitry, the communication interface and processing circuitry of the UE being configured to perform one or more of the actions described herein as performed by the wireless device 130.

21. The host of the previous embodiment, wherein the cellular network further includes a network node configured to communicate with the UE to transmit the user data from the UE to the host.

22. The host of the previous 2 embodiments, wherein:
the processing circuitry of the host is configured to execute a host application, thereby providing the user data; and
the host application is configured to interact with a client application executing on the UE, the client application being associated with the host application.

23. A method implemented by a host configured to operate in a communication system that further includes a network node and a user equipment (UE), the method comprising:
at the host, receiving user data transmitted to the host via the network node by the UE, wherein the UE performs one or more of the actions described herein as performed by the wireless device 130.

24. The method of the previous embodiment, further comprising:
at the host, executing a host application associated with a client application executing on the UE to receive the user data from the UE.

25. The method of the previous embodiments, further comprising:
at the host, transmitting input data to the client application executing on the UE, the input data being provided by executing the host application,
wherein the user data is provided by the client application in response to the input data from the host application.

### REFERENCES

1. RP-213645, “New SID: Study on low-power Wake-up Signal and Receiver for NR”, RAN plenary #94, December 2021.
2. RP-222644, “Revised SID on low-power WUS WUR for NR”, RAN plenary #97e, September 2022.

1-32. (canceled)

33. A method performed by a wireless device, the method being for handling a wake-up receiver, the wireless device operating in a wireless communications network, the method comprising:
determining, while the wireless device is in connected mode, whether or not to activate a wake-up receiver, wherein the determining is based on an expiration of a first timer;
initiating activation, while the wireless device is in connected mode, of the wake-up receiver based on a result of the determination; and
monitoring a downlink transmission with the activated wake-up receiver.

34. The method of claim 33, wherein at least one of:
the first timer is separately configured from a second timer, wherein the second timer is a connected mode discontinued reception (cDRX) timer;
the wireless device determines to activate the wake-up receiver after expiration of the first timer;
the wireless device determines to activate the wake-up receiver after expiration of the first timer and after monitoring downlink transmission with cDRX during a first period of time; and
cDRX operation is one of long and short.

35. The method of claim 34, wherein at least one of:
the first timer is used instead of the second timer;
the wireless device determines to activate the wake-up receiver after expiration of the first timer and refrains from monitoring downlink transmission with cDRX during a second period of time;
the expiration of the first timer triggers an always-on or continuous operation of the wake-up receiver;
cDRX operation is one of long and short;
the wireless device determines to activate the wake-up receiver after expiration of the first timer and refrains from monitoring downlink transmission with cDRX during a second period of time, wherein the cDRX is long; and
the wireless device determines to activate the wake-up receiver after expiration of the first timer and refrains from monitoring downlink transmission with cDRX during a second period of time, wherein the cDRX is short.

36. The method of claim 34, further comprising at least one of:
sending a first indication to a network node operating in the wireless communications network, the first indication indicating a capability of operation of the wake-up receiver;
receiving a second indication from the network node, the second indication indicating a configuration of usage or operation of the wake-up receiver in connected mode;
sending a third indication to the network node, the third indication indicating a wish to be kept in connected mode with the wake-up receiver; and
receiving a fourth indication from the network node, the fourth indication indicating an instruction to remain in connected mode with the wake-up receiver.

37. The method of claim 36, wherein a second indication indicates at least one of:
an on/off configuration;
one or more properties of the first timer;
a length of a duty cycle of the wake-up receiver;
a first parameter indicating the second timer is reused for the wake-up receiver;
a further indication indicating whether always-on wake-up receiver or duty-cycled wake-up receiver is to be used;
a third timer to switch from always-on wake-up receiver and duty-cycled wake-up receiver;
a power state to be used by a main receiver of the wireless device;
a fourth timer to switch from duty-cycled wake-up receiver operations;
a time gap between a wake-up signal occasion and start of a search space of a physical downlink control channel;
wake-up receiver resources to be monitored by the wireless device; and
a configuration of control signalling for enabling and/or disabling operation of wake-up signal.

38. The method of claim 37, wherein at least one of:
the second indication is comprised in an extension of a DRX configuration information element;
the second indication is comprised in an extension of a Physical Cell Group configuration information element;
the third indication is comprised in a UE assistance information message; and
the wireless device indicates a preference for a configuration of the wake-up receiver in UE assistance information.

39. The method of claim 33, wherein a second indication indicates a second parameter indicating operation with the wake-up receiver replaces monitoring with long and/or short DRX.

40. The method of claim 34, wherein at least one of:
the connected mode is a Radio Resource Control (RRC) Connected mode;
a separately configured timer is a WUR-inactivity timer;
the activation of the wake-up receiver is to monitor a downlink wake-up signal;
a main radio receiver of the wireless device is configured to be in a sleep mode during wake-up receiver operation;
the main radio receiver of the wireless device is configured to operate with a plurality of sleep modes during operation of the wake-up receiver;
the plurality of sleep modes comprise at least one of: an ultra-low sleep mode, a light sleep mode, a deep sleep mode and a micro-sleep mode;
the sleep mode is configured to be chosen for operation based on a type of wake-up radio operation;
the type of wake-up radio operation is one of: always-on and duty-cycled wake-up radio operation; and
first start and restart conditions of the first timer are the same as second start and restart conditions of the second timer.

41. A method of handling a wake-up receiver performed by a network node operating in a wireless communications network, the method comprising:
sending a second indication to a wireless device operating in the wireless communications network, the second indication indicating a configuration of usage or operation of the wake-up receiver in connected mode, the wake-up receiver being comprised in the wireless device;
wherein whether or not to activate the wake-up receiver is based on an expiration of a first timer.

42. The method of claim 41, wherein at least one of:
the configuration configures the wireless device to determine, while the wireless device is in connected mode, whether or not to activate the wake-up receiver, based on an expiration of the first timer;
the first timer is separately configured from a second timer, wherein the second timer is a connected mode discontinued reception (cDRX) timer;
the wireless device is configured to determine to activate the wake-up receiver after expiration of the first timer;
the wireless device is configured to determine to activate the wake-up receiver after expiration of the first timer and after monitoring downlink transmission with cDRX during a first period of time; and
cDRX operation is one of long and short.

43. The method of claim 42, wherein at least one of:
the first timer is used instead of the second timer;
the wireless device (130) is configured to determine to activate the wake-up receiver after expiration of the first timer and to refrain from monitoring downlink transmission with cDRX during a second period of time;
the expiration of the first timer triggers an always-on or continuous operation of the wake-up receiver;
cDRX operation is one of long and short;
the wireless device is configured to determine to activate the wake-up receiver after expiration of the first timer and to refrain from monitoring downlink transmission with cDRX during a second period of time, wherein the cDRX is long, and
the wireless device is configured to determine to activate the wake-up receiver after expiration of the first timer and to refrain from monitoring downlink transmission with cDRX during a second period of time, wherein the cDRX is short.

44. The method of claim 42, further comprising at least one of:
receiving a first indication from the wireless device, the first indication indicating a capability of operation of the wake-up receiver;
receiving a third indication from the wireless device, the third indication indicating a wish to be kept in connected mode with the wake-up receiver;
sending a fourth indication to the wireless device, the fourth indication indicating an instruction to remain in connected mode with the wake-up receiver; and
sending a downlink transmission to the wireless device to be detected by the wake-up receiver, wherein the downlink transmission is a downlink wake-up signal.

45. The method of claim 44, wherein the second indication indicates at least one of:
an on/off configuration;
one or more properties of the first timer;
a length of a duty cycle of the wake-up receiver;
a first parameter indicating the second timer is reused for the wake-up receiver;
a further indication indicating whether always-on wake-up receiver or duty-cycled wake-up receiver is to be used;
a third timer to switch from always-on wake-up receiver and duty-cycled wake-up receiver;
a power state to be used by a main receiver of the wireless device;
a fourth timer to switch from duty-cycled wake-up receiver operations;
a time gap between a wake-up signal occasion and start of a search space of a physical downlink control channel;
wake-up receiver resources to be monitored by the wireless device; and
a configuration of control signalling for enabling and/or disabling operation of wake-up signal.

46. The method of claim 45, wherein least one of:
the second indication is comprised in an extension of a DRX configuration information element;
the second indication is comprised in an extension of a Physical Cell Group configuration information element;
the third indication is comprised in a UE assistance information message; and
a preference by the wireless device for a configuration of the wake-up receiver is indicated in UE assistance information.

47. The method of claim 41, wherein the second indication indicates a second parameter indicating operation with the wake-up receiver replaces monitoring with long and/or short DRX.

48. The method of claim 42, wherein at least one of:
the connected mode is a Radio Resource Control (RRC) Connected mode;
the separately configured timer is a WUR-inactivity timer;
the activation of the wake-up receiver is to monitor a downlink wake-up signal;
a main radio receiver of the wireless device is configured to be in a sleep mode during wake-up receiver operation;
the main radio receiver of the wireless device is configured to operate with a plurality of sleep modes during operation of the wake-up receiver;
the plurality of sleep modes comprise at least one of: an ultra-low sleep mode, a light sleep mode, a deep sleep mode and a micro-sleep mode;
the sleep mode is configured to be chosen for operation based on a type of wake-up radio operation;
the type of wake-up radio operation is one of always-on and duty-cycled wake-up radio operation; and
first start and restart conditions of the first timer are the same as second start and restart conditions of the second timer.

49. A wireless device for handling a wake-up receiver, the wireless device being configured to operate in a wireless communications network, wherein the wireless device comprises:
processing circuitry and a memory, the memory containing instructions executable by the processing circuitry, whereby the wireless device is further configured to:
determine, based on an expiration of a first timer and while the wireless device is in connected mode, whether or not to activate a wake-up receiver;
initiate activation, while the wireless device is in connected mode, of the wake-up receiver based on a result of the determination; and
monitor a downlink transmission with the wake-up receiver configured to be activated.

50. The network node of claim 49, wherein at least one of:
the first timer is separately configured from a second timer, wherein the second timer is a connected mode discontinued reception (cDRX) timer;
the wireless device is further configured to determine to activate the wake-up receiver after expiration of the first timer;
the wireless device is further configured to determine to activate the wake-up receiver after expiration of the first timer and after monitoring downlink transmission with cDRX during a first period of time; and
cDRX operation is one of long and short.

51. A network node for handling a wake-up receiver, the network node being configured to operate in a wireless communications network, the network node comprising:
processing circuitry and a memory, the memory containing instructions executable by the processing circuitry whereby the network node is configured to:
send a second indication to a wireless device configured to operate in the wireless communications network, the second indication being configured to indicate a configuration of usage or operation of the wake-up receiver in connected mode, the wake-up receiver being configured to be comprised in the wireless device;
wherein whether or not to activate the wake-up receiver is configured to be based on an expiration of a first timer.

52. The network node of claim 51, wherein at least one of:
the configuration configures the wireless device to determine, while the wireless device is in connected mode, whether or not to activate the wake-up receiver, based on an expiration of the first timer;
the first timer is separately configured from a second timer, wherein the second timer is a connected mode discontinued reception (cDRX) timer;
the wireless device is configured to determine to activate the wake-up receiver after expiration of the first timer;
the wireless device is configured to determine to activate the wake-up receiver after expiration of the first timer and after monitoring downlink transmission with cDRX during a first period of time; and
cDRX operation is one of long and short.
